(19) United States
(12) Patent Application Publication
(10) Pub. No.: US 2008/0077741 A1
(43) Pub. Date: Mar. 27, 2008

(54) Method and apparatus for dynamically managing memory in accordance with priority class

(75) Inventors: Takanori Yasui, Kawasaki (JP); Hideki Shiono, Kawasaki (JP); Masaki Hiromori, Kawasaki (JP); Hirofumi Fujiyama, Kawasaki (JP); Satoshi Tomie, Kawasaki (JP); Yasuhiro Yamauchi, Kawasaki (JP); Sadayoshi Handa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/882,099

(22) Filed: Jul. 30, 2007

(30) Foreign Application Priority Data
Sep. 21, 2006 (JP) 2006-255950

(51) Int. Cl. G06F 12/00

(52) U.S. Cl. 711/129

(57) ABSTRACT

A dynamic memory management method and apparatus wherein an area of a memory is partitioned into a plurality of areas to form memory banks. The different priority classes share the memory banks. A policer (write controller) dynamically assigns input frame data of a plurality of classes having different degrees of priority to memory banks in accordance with the degrees of priority and stores the data there for each priority class. A scheduler (read controller) sequentially reads out the data from the frame data stored in the memory bank assigned to the class having the highest degree of priority and transmits the same. For storage of frame data of a priority of class input in a burst like manner, a plurality of memory banks are assigned to that priority class so as to raise the burst tolerance. By controlling writing and reading of data in units of memory banks, the control can be simplified. Due to this, the efficiency of usage of memory is improved and the write/read control is simplified.

### BACKGROUND OF THE INVENTION

1. Field of the Invention

The present invention relates to a method and apparatus for dynamically managing memory in accordance with a priority class (corresponding to “Quality of Service” (QOS)). In frame processing in the Ethernet® etc., priority processing for passing/discarding frame data in accordance with the priority class is carried out by using a large capacity memory storing frame data. The memory is managed in the frame processing for each priority class by the individual memory management system using individual memories corresponding to the different classes and the shared memory management system using a single shared memory for a plurality of classes.

The individual memory management system individually provides a memory for each class, therefore has the demerit that a large amount of memories becomes necessary in total, but each memory is used occupied for each one class, and data may be sequentially written into empty areas, therefore it has the merit that write/read operations can be easily controlled.

On the other hand, the shared memory management system has the merit that one memory can be used shared by a plurality of classes, so the total amount of memory may be small, but has the demerit that the memory management for control of sharing such as the management of the write area of each class becomes complex.

The present invention relates to a method and apparatus for dynamically managing memory which is neither the individual memory management system nor the shared memory management system, can effectively dynamically utilize memory writing data of a plurality of classes having different degrees of priority for a plurality of classes, and can easily control write/read operations.

2. Description of the Related Art

FIG. 44 shows an example of a system to which the present invention is preferably applied. In the example of the system configuration of the figure, the data output from a terminal X1 is bundled together with the data from the other terminal Y1 through a multiplexer and input to a first station S1. In this example, these data are transferred to a terminal X2 and a terminal Y2 through the first station S1, a second station S2, a third station S3, and a demultiplexer.

Here, assume that the terminal X1 handles data of classes (degrees of priority) of A and C, and the terminal Y1 handles the data of classes (degrees of priority) of B and D. The data are subjected to the priority processing at the stations in the priority order of the class A as the highest degree of priority followed by the class B, the class C, and the class D. Below, the priority processing of the data processed at the stations will be explained.

FIG. 45, FIG. 46, and FIG. 47 show the configurations of the internal portions of the stations. FIG. 45 shows the functional blocks for outputting the data input from the multiplexer to another station. As shown in the figure, MAC (Media Access Control) frames of local area networks LAN-1 to LAN-N are input from the multiplexer to an optical module 45-1, converted from optical signals to electric signals at the optical module 45-1, subjected to MAC frame processing at a MAC chip 45-2, and input to a frame discriminator 45-3 of a FPGA (field programmable gate array).

The frame discriminator 45-3 discriminates input frames and transfers the frame data to a policer 45-4. The policer 45-4 controls the write/discard operation of the frame data with respect to the memory 45-4. A scheduler 45-6 reads out the data from the memory 45-5 according to the priority order and transfers it to an EOS chip 45-7. The EOS chip 45-7 maps Ether® frames (MAC frames) to SONET frames and outputs the result to the optical module 45-8. The optical module 45-8 converts the data from an electrical signal to an optical signal and outputs the frame data to an opposing station.

FIG. 46 shows functional blocks for outputting the frame data input from another station to the multiplexer. These functional blocks perform processing in a reverse direction to the processing explained in FIG. 45. Note that, in order to transfer two-way communication data, each station is provided with the functional blocks shown in FIG. 45 and the functional blocks shown in FIG. 46 in the internal portion of the station.

FIG. 47 shows functional blocks for outputting the frame data input from another station to a different other station. For example, a second station S2 of FIG. 44 receives as input the SONET frame from the other station, demultiplexes the SONET frame to data for each destination by the SONET processing portion, switches these data to a route of the destination, composes the same to the SONET frame, and transmits the same to the next station.

Here, the prerequisite conditions of the configuration of the present invention will be explained. FIG. 48 shows the configuration of the internal portion of a station. As shown in the figure, between the policer (write controller) 48-1 and the scheduler (read controller) 48-2, memories corresponding to Qualities of Service A, B, C, and D are provided. Data having for example a 1 Gbps bandwidth input from a channel on an input side (exemplified as an earthen pipe) is assigned for each priority class by the policer (write controller) 48-1 and stored in memories corresponding to Qualities of Service A, B, C, and D in accordance with the degree of priority. Then, the scheduler (read) portion 48-2 reads out the data from the memory storing the data having a higher degree of priority to the output side with a higher priority.

The data having a low degree of priority is read out after the data having a higher degree of priority is read out and goes out from the output side. Accordingly, for example the data of the class D having the lowest degree of priority is read out when the data of classes A, B, and C are read out from corresponding memories and these memories become empty states and then is output from the output side.

The above relates to the normal operation, but there is a case where data is input from the input side with a predetermined bandwidth and the channels on the output side jam due to this or a case where a fault etc. causes the output frames to be temporarily stopped and the amount of the input data becomes larger than the amount of the output data. That is, there arises a case where processing is being performed to write data into the memory, but the amount of data read out from the memory becomes smaller than the amount of data written into the memory at certain instants.

For this reason, it becomes necessary to impart burst tolerance to the input data of the above predetermined bandwidth for a certain constant period. For example, in order to enable the storage of data in the memory for a term of for example 15 ms even in a case where data is input from the input side with the 1 Gbps bandwidth and the read processing on the output side is completely stopped, it is necessary to secure a memory capacity of 15 Mbits or more. This is found by the following equation.

1 Gbps×15 ms=15 Mbits

Here, in order to provide memories corresponding to for example four Qualities of Service A to D, 60 Mbits of memory (=15 Mbits×4) become necessary. When configuring the system in this way, even when the data of any class among A to D is concentratedly input, this can be tolerated for 15 ms. However, since the memory is not shared among classes, this configuration is inefficient in the point of effective utilization of memory.

In order to satisfy the predetermined requirement for burst tolerance, it is necessary to mount a memory for storing the input burst data. As the configuration of that memory, there are the individual memory management system and the shared memory management system as mentioned before.

In the individual memory management system, as shown in FIG. 49, an individual memory is provided for each of the classes A to D, input frames are assigned to each of the classes at the policer (write controller) 48-1 and stored in memories 49-1 to 49-4, and the scheduler (read controller) 48-2 performs the scheduling so as to sequentially read out data from the memory storing the data having the highest degree of priority (QOS) therein, therefore the processing for writing and reading data becomes easy. However, even when for example there is empty space in a memory having a low priority class and the memory of the highest degree of priority is full, the empty memory of the other class cannot be used.

As opposed to this, in the shared memory management system, as shown in FIG. 50, the memory 50-1 is shared by the classes A to D. All classes use the memory 50-1 to store data, therefore at least a memory capacity of the 15 Mbits of the burst tolerance of the highest degree of priority A should be provided. Even when the data is concentratedly input to only the class A with a 1 Gbps bandwidth or even when data of any of the classes A to D is sparsely input, the memory 50-1 is shared among these classes, therefore the memory 50-1 becomes a memory space commonly used by the classes.

However, in the shared memory management system, scheduling is carried out according to the priority order to read out the data from the memory 50-1, therefore a memory area in which the data of the class having a high priority order is stored becomes a sparse empty area, memories (empty management memory 50-2 and chain management memory 50-3) for managing which area of the memory 50-1 is empty and up to which area is the data written become necessary, and the management processing thereof becomes complex.

Explaining the capacities of the empty management memory 50-2 and the chain management memory 50-3, when assuming that the memory space of the memory 50-1 for storing for example 15 Mbits of data is partitioned into areas of units of “pages” and for example 1 page has a size of 128 bytes, the capacities of the empty management memory 50-2 and the chain management memory 50-3 become as follows.

Empty management memory capacity:

15 Mbits÷1024 bits(128 bytes)=14649(=3939 hex[14 bits])

14649×14 bits=205086 bits

Namely, in order to sequentially connect empty pages in the 14649 pages, a memory for storing the 14 bits of information showing the address of the next following empty page is necessary. In the end, a memory capacity of 205086 bits becomes necessary.

Chain management memory capacity:

15 Mbits÷1024 bits(128 bytes)=14649(=3939 hex[14 bits])

14649×15 bits=219735 bits

Namely, a memory for storing the total 15 bits of the 14 bits of the address of the next continuing data storage page and 1 bit indicating whether or not it is the last page is necessary. In the end, a memory capacity of 219735 bits becomes necessary.

For the individual memory management system and the shared memory management system, Japanese Patent Publication (A) No. 11-65973 etc. disclose a method of utilization of memory of a communication I/F board partitioning the memory into individual areas of the different channels and a shared area, securing at least one individual area of the memory for each channel, enabling a channel at which load is concentrated to handle the concentration of load by using the shared area, and further enabling the memory area of a low load channel and unused channel to be utilized by another channel.

### SUMMARY OF THE INVENTION

An object of the present invention is to provide a memory management method and apparatus improving the inefficient use of memory in the conventional individual memory management system. Enabling simpler control of the write/read processing in comparison with the conventional shared memory management system, and enabling dynamic effective utilization of memory for writing data of a plurality of classes having different degrees of priority by classes.

To attain the above object, according to the memory configuration of the present invention, an area of a memory (1-1) is partitioned into a plurality of areas to form memory banks. The different priority classes share the memory banks. A policer (write controller) (1-2) dynamically assigns input frame data of a plurality of classes having different degrees of priority to memory banks in accordance with the degrees of priority and stores the data there for each priority class. A scheduler (read controller) (1-3) sequentially reads out the data from the frame data stored in the memory bank assigned to the class having the highest degree of priority and transmits the same. For storage of frame data of a priority of class input in a burst like manner, a plurality of memory banks are assigned to that priority class so as to raise the burst tolerance. By controlling writing and reading of data in units of memory banks, the control can be simplified. Due to this, the efficiency of usage of memory is improved and the write/read control is simplified.

### BRIEF DESCRIPTION OF THE DRAWINGS

The above object and features of the present invention will be more apparent from the following description of the preferred embodiments given with reference to the accompanying drawings, wherein:

FIG. 1 is a diagram showing a memory configuration of a dynamic memory management method according to the present invention;

FIG. 2 is a diagram showing an embodiment of a class buffer fixed assignment according to the present invention;

FIG. 3 is a diagram showing an embodiment of a class buffer and spare area dynamic assignment according to the present invention;

FIG. 4 is a diagram showing an example of the circuit configuration for realizing an embodiment of the present invention;

FIGS. 5A to 5C are diagrams showing a specific example of a class judgment in the present invention;

FIGS. 6A and 6B are diagrams showing data configurations of memories in a first example of the configuration of the present invention;

FIGS. 7A and 7B are diagrams showing an initial state of memory in the first example of configuration of the present invention;

FIGS. 8A and 8B are diagrams showing a first case (state of completion of reception and write operation of 64 bytes of data of class A);

FIGS. 9A and 9B are diagrams showing a second case (state of completion of reception and read operation of 64 bytes of data of class A and after the operation of the first case);

FIGS. 10A and 10B are diagrams showing a third case (state of completion of reception and write operation of 1500 bytes of data of class B);

FIGS. 11A and 11B are diagrams showing a fourth case (state during reception and read operation of 1500 bytes of data of class B);

FIGS. 12A and 12B are diagrams showing a fifth case (state of completion of reception and read operation of 1500 bytes of data of class B, then reception and write operation of 64 bytes of data of class C);

FIGS. 13A and 13B are diagrams showing a sixth case (state of completion of reception and read operation of 1500 bytes of data of class B, then reception and write operation of second 64 bytes of data of class C);

FIG. 14 is a diagram showing an example of a technique for judgment of a full state of a memory bank;

FIG. 15 is a diagram showing a processing flow of a basic operation at the time of reception of a 64-byte frame of the class A;

FIGS. 16A and 16B are diagrams showing a state of operation where the memory banks #1 to #4 store data of classes A to D and the memory bank #4 (class D) is full;

FIGS. 17A and 17B are diagrams showing a state of operation where 64 bytes of data of the class D are newly received after the state of FIGS. 16A and 16BA;

FIGS. 18A and 18B are diagrams showing an example of operation for overwriting high priority data;

FIGS. 19A and 19B are diagrams showing a state of operation when receiving 64 bytes of data of the class A after the state of FIGS. 18A and 18B;

FIGS. 20A and 20B are diagrams showing a state of operation when further receiving 64 bytes of data of the class A after the state of FIGS. 19A and 19B;

FIGS. 21A and 21B are diagrams showing a state of operation for executing the write processing of the data of the class A up to the full state of the memory bank #4;

FIGS. 22A and 22B are diagrams showing a state of operation for executing the processing for further receiving 64 bytes of data of the class A and writing the data of the class A into the memory bank #5;

FIGS. 23A and 23B are diagrams showing a state of operation of performing the write processing of the data of the class A up to the full state of the memory bank #5;

FIGS. 24A and 24B are diagrams showing a state of operation of further receiving the data of the class A and clearing the memory bank information of the class C;

FIGS. 25A and 25B are diagrams showing an example of operation of receiving 64 bytes of data of the class A and writing the same into the memory bank #3;

FIG. 26 is a diagram showing a second example of the configuration of memory banks in the present invention;

FIGS. 27A and 27B are diagrams showing the initial state of memory in the second example of configuration of the present invention;

FIGS. 28A and 28B are diagrams showing a state of operation of receiving data of the class A in the second example of configuration;

FIGS. 29A and 29B are diagrams showing a state of operation of receiving 10 frames of the data of the class A in the second example of configuration;

FIGS. 30A and 30B are diagrams showing a state of operation of receiving 50 frames of the data of the class A and further receiving 50 frames of the data of the class B in the second example of configuration;

FIGS. 31A and 31B are diagrams showing a state of operation of receiving 50 frames of the data of the class C after the state of FIGS. 30A and 30B;

FIGS. 32A and 32B are diagrams showing a state of operation of receiving 10 frames' worth of the data of the class D after the state of FIGS. 31A and 31B;

FIGS. 33A and 33B are diagrams showing a state of operation of further receiving 10 frames' worth of the data of the class D after the state of FIGS. 32A and 32B;

FIGS. 34A and 34B are diagrams showing a state of operation of securing up to the maximum limit of areas for the classes A and B and securing the lowest limit of areas for the classes C and D;

FIG. 35 is a diagram showing an example of operation of immediately writing the data of a low priority class without discarding it in a case when writing data having a high degree of priority into a memory bank;

FIGS. 36A and 36B are diagrams showing a state of operation of storing the data in all memory banks and writing 64 bytes of received data of the class C;

FIGS. 37A and 37B are diagrams showing a state of operation when receiving 64 bytes of data of the class A after the state of FIGS. 36A and 36B;

FIGS. 38A and 38B are diagrams showing a state of operation when further receiving the data of the class A after the state of FIGS. 37A and 37B;

FIG. 39 is a diagram showing a method of immediately writing the data of a low priority class in units of packets without discarding it in a case when writing data having a high degree of priority into a memory bank;

FIGS. 40A and 40B are diagrams showing an example of operation of immediately writing the data of a low priority class in units of packets without discarding it in a case when writing data having a high degree of priority into a memory bank;

FIGS. 41A and 41B are diagrams showing a state where all memory banks store data, and 2 frames' worth of the data of class C are stored in the memory bank #3.

FIGS. 42A and 42B are diagrams showing a state of operation of receiving the data of the class A after the state of FIGS. 41A and 41B and overwriting that on the data of the class C;

FIGS. 43A and 43B are diagrams showing a state of operation when further receiving the data of the class A after the state of FIGS. 42A and 42B;

FIG. 44 is a diagram showing an example of a system to which the present invention is preferably applied;

FIG. 45 is a diagram showing functional blocks for outputting the data input from the multiplexer to another station;

FIG. 46 is a diagram showing functional blocks for outputting the frame data input from another station to the multiplexer;

FIG. 47 is a diagram showing functional blocks for outputting the frame data input from another station to a different other station;

FIG. 48 is a diagram showing the configuration of an internal portion of the station;

FIG. 49 is a diagram showing an individual memory management system; and

FIG. 50 is a diagram showing a shared memory management system.

### DESCRIPTION OF THE PREFERRED EMBODIMENTS

According to a first embodiment of the invention, there is provided a method of dynamic management of memory in accordance with a priority class receiving as input frame data of a plurality of classes of different degrees of priority and storing or discarding the frame data in/from a memory of the frame data in accordance with the priority class of the frame data, the method of dynamic management of memory comprising partitioning an area of the memory into a plurality of areas to form memory banks and having the different priority classes share the memory banks, dynamically assigning empty memory banks to the storage of frame data of the different priority classes, and controlling the writing, reading, and discarding of the frame data with respect to each memory bank assigned for each priority class.

According to a second embodiment, there is provided a method of dynamic management of memory in accordance with a priority class of the first embodiment further comprising defining a capacity smaller than a largest capacity among memory capacities for the priority classes required for storage of frame data for each of the priority classes input in a burst within a predetermined time as the capacity of the memory banks, and storing a plurality of frame data for each priority class input in a burst by assigning the plurality of memory banks.

According to a third embodiment, there is provided a method of dynamic management of memory in accordance with a priority class of the first embodiment further comprising setting a lowest limit of usable memory and a maximum limit of usable memory for each of the priority classes and, when assigning the memory banks to the storage of the frame data of the different priority classes, assigning at least a memory bank having the lowest limit of usable memory for a priority class for which the lowest limit of usable memory is set and assigning memory banks up to the maximum limit of usable memory for a priority class in which the maximum limit of usable memory is set.

According to a fourth embodiment, there is provided a method of dynamic management of memory in accordance with a priority class of the first embodiment further comprising, when storing frame data of a higher priority class in a memory bank which has been already assigned to the storage of frame data of a low priority class, sequentially writing frame data of the higher priority class from the area where the frame data of the low priority class has been already read out from the memory bank and continuing to read out frame data of the low priority class without discarding the frame data of the low priority class until a write pointer indicating the address for writing the frame data of the higher priority class catches up with a read pointer indicating the address for reading the frame data of the low priority class from the memory bank.

According to a fifth embodiment, there is provided an apparatus for dynamic management of memory in accordance with a priority class receiving as input frame data of a plurality of classes of different degrees of priority and storing or discarding the frame data in or from the memory in accordance with the priority class of the frame data, the apparatus for dynamic management of memory in accordance with a priority class comprising memory banks configured by partitioning the area of the memory into a plurality of areas and a write controller and a read controller for controlling the writing, reading, and discarding of the frame data in units of the memory banks and having the different priority classes share the memory banks, dynamically assigning empty memory banks to the storage of frame data of the different priority classes, and controlling the writing, reading, and discarding of the frame data with respect to each memory bank assigned for each priority class.

According to the present invention, by having different priority classes share memory banks obtained by partitioning the area of the memory into a plurality of areas and dynamically assigning memory banks to the priority classes, individual memories become unnecessary, and the memory for storing the data need only have a capacity between the conventional individual memory management system and shared memory management system. The memory capacity of each priority class can be dynamically changed, so when a larger memory is required by a class of a higher degree of priority, memory capacity can be assigned to the memory area for that higher class, and when a memory area of a class of a low degree of priority is required, memory capacity can be assigned to the memory area for that low class. By assigning memory in accordance with the degree of priority in accordance with the situation with a relatively small memory capacity, the memory can be effectively and actively used.

Further, by controlling the assignment of memory to the different priority classes in units of memory banks, a relatively simple control circuit can dynamically assign and change memory in accordance with the priority class. Further, by providing a plurality of memory banks having smaller memory capacities than that required for the storage of frame data input in bursts and storing a plurality of frame data input in bursts by using a plurality of memory banks, the memory can be efficiently used.

Further, by assigning at least a memory bank having the lowest limit of usable memory to a priority class for which the lowest limit of usable memory is set and assigning memory banks up to the maximum limit of usable memory to a priority class for which the maximum limit of usable memory is set, use of all memory banks for the storage of frame data of a high degree of priority is prevented. Even when a fault causing delay of reading of frame data of a high degree of priority occurs, this can be prevented from affecting the storage of frame data of a low priority class. At the same time, service guaranteeing the lowest limit of bandwidth for the low priority class can be provided.

Further, when storing frame data of a higher priority class in a memory bank in which frame data of a low priority class is already stored, by continuing to read the frame data without discarding the frame data of the low priority class until the write pointer for writing the frame data of a higher priority class catches up with the read pointer for reading the frame data of a low priority class, more effective utilization of the memory can be achieved.

The preferred embodiments of the present invention will be described in further detail below while referring to the attached figures.

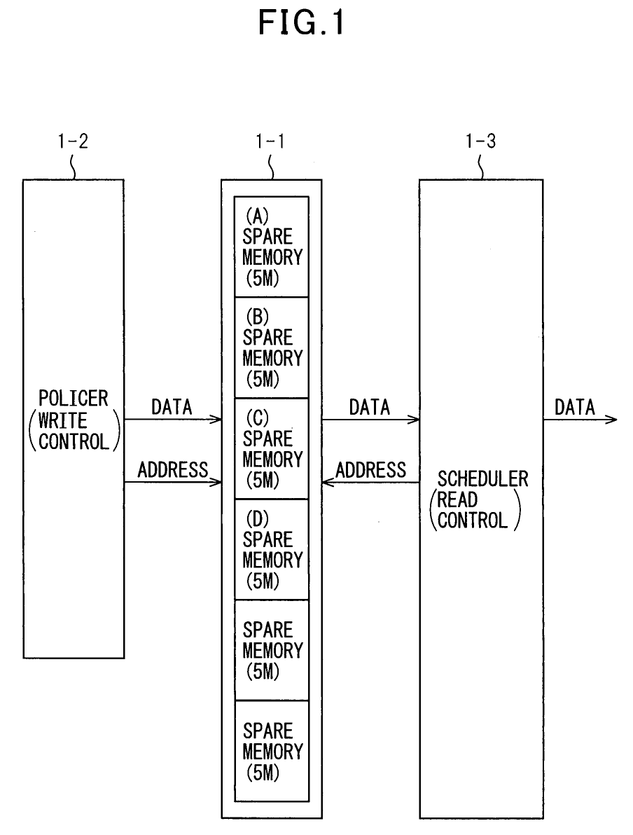

FIG. 1 shows a memory configuration of a dynamic memory management system according to the present invention. The dynamic memory management system according to the present invention partitions the memory space to a plurality of areas each having a capacity less than the burst tolerance and dynamically assigns (that is dynamically changes) these partitioned areas (hereinafter referred to as “memory banks”) with respect to classes. As the dynamic assignment method, a plurality of memory banks are adaptively used as spare areas at each of the classes, and empty spare areas are assigned to classes needing the data storage.

The dynamic memory management system according to the present invention uses memory having a capacity exceeding 15 Mbits as the total memory capacity. In the example of configuration shown in FIG. 1, it uses a memory 1-1 using six memory banks each having a capacity of 5 Mbits and thereby having a total capacity of 30 Mbits' (=5 Mbits×6). Assuming that an absolute capacity of the lowest limit required for the burst tolerance is for example 15 Mbits, a memory provided with a capacity of about 30 Mbits or double that may be used.

While explained in the following embodiments as well, as an initial default capacity of the buffer area for the storage of data of classes A, B, C, and D, one memory bank, that is, the 5 Mbits, is assigned to each class, but the policer (write controller) 1-2 and the scheduler (read controller) 1-3 control the writing and reading so as to also enable the use of those areas as spare areas for the storage of data of other classes. Further, it is assumed that two memory banks of 5 Mbits are prepared for use as spare areas from the first. Therefore, a memory having 30 Mbits' worth of capacity in total is used.

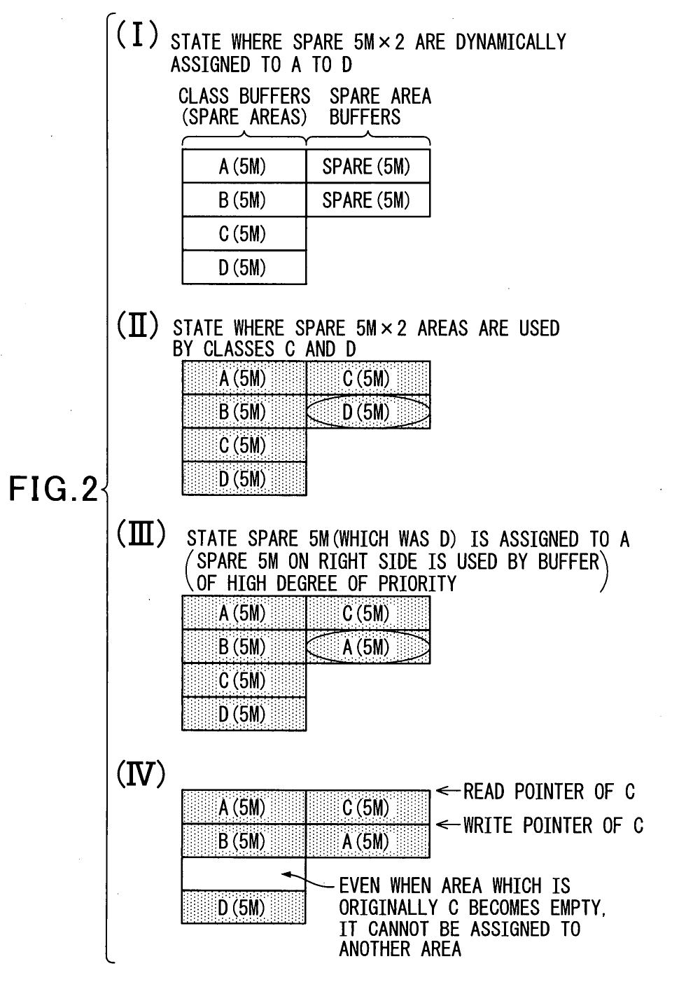

FIG. 2 shows an embodiment of a class buffer fixed assignment according to the present invention. This embodiment, as shown in (i) of FIG. 2, makes it possible to assign four memory banks on the left side as class buffers for the classes A to D in a fixed manner and dynamically assign the two memory banks on the right side for the classes A to D as spare area buffers.

The first state shown in (ii) of FIG. 2 shows the example where all class buffers on the left side are used for the storage of data of classes A, B, C, and D and all of spare area buffers on the right side are used for the storage of data of the classes C and D. The second state shown in (iii) of FIG. 2 shows the example where a spare area (lower level on right side) assigned to the class D having the lowest degree of priority is assigned to the class A since the data of the class A of the high degree of priority is input from the above first state and 10 Mbits' worth of data in total are stored in the class buffer of 5 Mbits on the left side to which the data of the class A of the high degree of priority was initially assigned and the spare area buffer of 5 Mbits on the right side.

Even when there is a further change from the second state shown in (iii) of FIG. 2 to a third state shown in (iv) of the same figure, that is, even when the read pointer of the buffer area of the class C advances and the buffer area of the class C which was initially assigned becomes empty, because of the system of assigning this buffer area to the class C in the fixed manner, even if the data of the class A is input in this state and it becomes necessary to store the same in the buffer, the data is not stored in the empty area of the buffer area of the class C, but overwrites the data of the class of the high degree of priority in only the spare area on the right side, so there is the demerit that the buffer area on the left side is not effectively utilized.

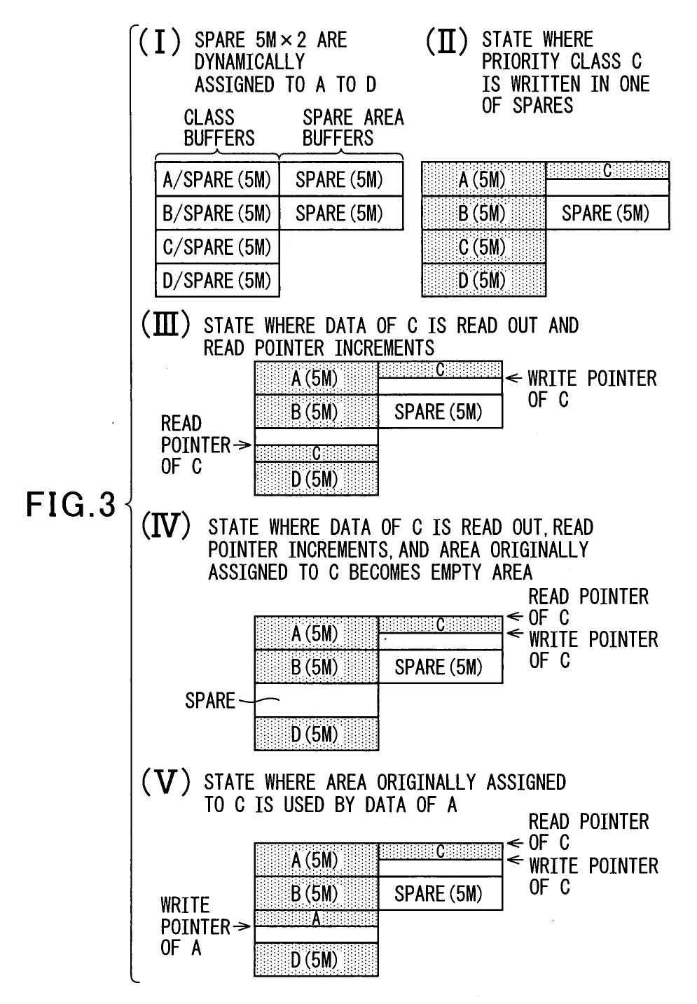

Therefore, as an embodiment of the present invention improving on this, an explanation will be given below of a method for dynamic assignment of class buffers and spare areas. This method assigns memory banks on the left side by the initial default to the storage of data of the classes A, B, C, and D as class buffers as shown in (i) of FIG. 3, but makes it possible to use the memory banks for any class as spare area buffers along with the progress of operation after that. Naturally the spare area buffers on the right side are spare areas which can be assigned with respect to any class.

(ii) of FIG. 3 shows a state where each 5 Mbits of data of each of the classes A, B, C, and D are stored in each of the class buffers assigned by the initial default on the left side and a state where the data of the class C is written in the spare area buffer in the upper level on the right side up to the middle. (iii) of FIG. 3 shows a state where time passes from the state of (ii) of FIG. 3, the data of the class C is read out, and the read pointer of the class buffer of the class C of the initial default assignment advances. (iv) of FIG. 3 shows a state where the data of the class C is further read, and all of the data in buffer areas of the class C on the left side are read out.

At this time, the buffer area originally assigned to the class C by the initial default becomes an empty area and is released as a spare area usable by any class. (v) of FIG. 3 shows a state where the data of the class A is input after the above state, and the data of the class A is written into the buffer area originally assigned to the class C. In this way, the embodiment shown in FIG. 3 dynamically uses any memory bank as the buffer area of any class so far as it is in the empty state.

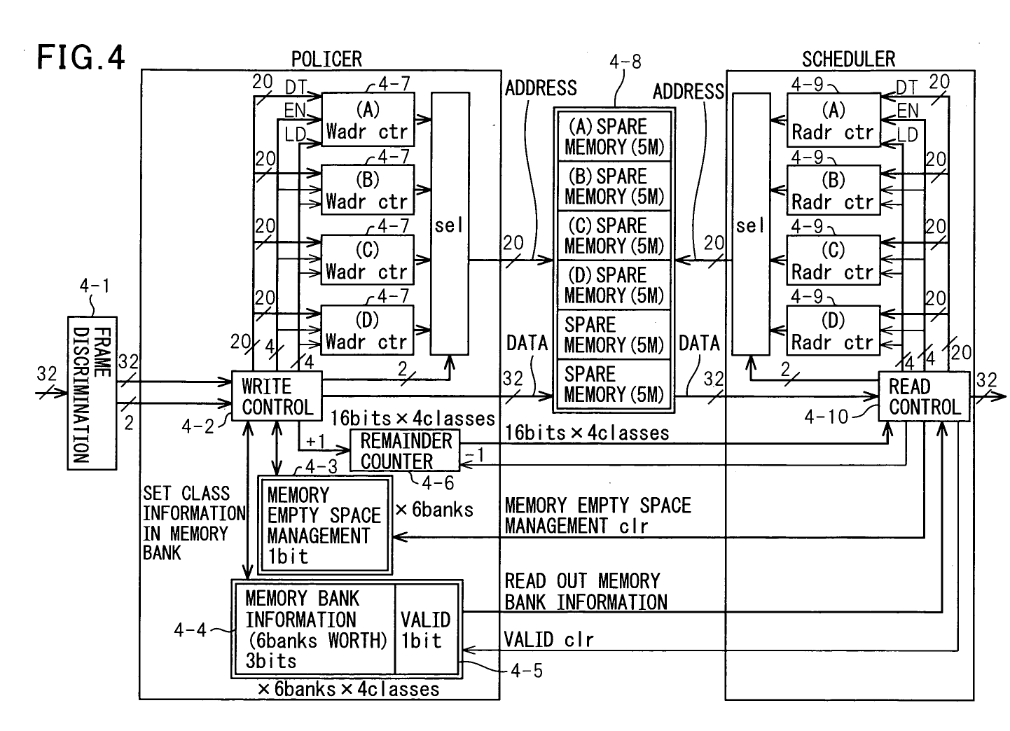

FIG. 4 shows an example of the circuit configuration for realizing the embodiment of the class buffer fixed assignment or class buffer and spare area dynamic assignment mentioned above. Note that the number of bits etc. illustrated in the following explanation are just examples; the present invention is not limited to this. In FIG. 4, a received frame input from the left side is judged as to class at the frame discriminator 4-1, then the 32 bits of the data bits and the 2 bits of the class discrimination bits are transferred to the write controller 4-2.

The write controller 4-2 refers to the memory empty space management bit 4-3 showing the empty state of each memory bank and judges whether or not there is an empty space in the memory bank. When there is an empty space in the memory bank, the data of the received frame is written in it. When there is no empty space in the memory bank, the data of the received frame is discarded.

When the class data is received and there is an empty space in the memory bank, in order to make the empty memory bank the data storage area, the memory empty space management bit 4-3 of the memory bank is set to indicate the congested state, the discrimination information of the memory bank (3 bits representing six memory banks) is set in the memory bank information portion 4-4 corresponding to the class, the valid data is stored in the memory bank, and a valid bit 4-5 indicating that reading is necessary is set.

Then, “1” is added to a remainder counter 4-6 indicating the number of received frames stored corresponding to the class. Further, the write controller 4-2 judges if a received frame length exceeds an empty area count of the memory bank. When the received frame length exceeds the empty area count of the memory bank, the frame is not written into the memory bank. Namely, one received frame is not stored over a plurality of memory banks.

Further, if the minimum frame length of the received frame is for example 64 bytes, when the empty area count of the memory bank is 15 or less, that is, the remaining amount of write addresses of the memory bank is 15 or less, the frame is also not written into the memory bank. This is because, when assuming that each word (32 bits) of data is stored at one address of the memory bank, 16 addresses' worth of empty area is required for storing the 64 bytes of data and 1 frame's worth of the data or more cannot be stored when the empty area count is 15 or less.

The write address controller (Wadr_ctr) 4-7 in the policer is provided corresponding to each of the classes A, B, C, and D. Each outputs the address value of the memory bank 4-8 incremented by “1” whenever 32 bits (1 word) of frame data is written into the memory bank 4-8.

Then, when the last data of the received frame is written into the memory bank 4-8, the write address controller (Wadr_ctr) 4-7 stops the count. When receiving the next frame, it increments the stopped address value by “1” then stops the count when the header data to the last data of the received frame are written in the memory bank 4-8 in a repetition of the operation.

When the write controller 4-2 writes the data up to near the last address of one memory bank 4-8, it performs processing for referring to the memory empty space management bit 4-3 to judge whether or not there is another empty memory bank and writing the data of the next received frame into the empty memory bank.

The read controller 4-10 in the scheduler performs the control so as to sequentially read out data from the class of the highest degree of priority. Namely, it continuously reads out all data of the class A by the read address controller (Radr_ctr) of the class A until the value of the remainder counter 4-6 becomes zero. When finishing reading out the data of the class A, its starts the reading of the data of the class B by the read address controller (Radr_ctr) 4-9 of the next class B.

When finishing reading all data of the class B, the read address controller (Radr_ctr) 4-9 of the next class C starts to read the data of the class C, then when finishing reading all of the data of the class C, the read address controller (Radr_ctr) 4-9 of the next class D reads the data of the class D for read processing in that order.

In the read control, when the read processing proceeds up to the last address area of each memory bank 4-8 or when the value of the remainder counter 4-6 corresponding to each class becomes zero, the memory empty space management bit 4-3 corresponding to the memory bank and the valid bit 4-5 are cleared. The remainder counter 4-6 is provided for each class, is incremented by “1” whenever 1 frame's worth of the data is written into the memory, and is decremented by “1” whenever 1 frame's worth of the data is read out from the memory.

On the reading side, when the read operation proceeds up to the last address of one memory bank 4-8 and the value of the remainder counter 4-6 of the class of a high degree of priority is not zero, the valid bit 4-5 of the memory bank information 4-4 of that class is referred to. When that valid bit is set, the read processing of the data continues from the memory bank in which the data of that class is stored.

When the valid bit of the class of a high degree of priority is not set, the read processing of the data of the class of next highest degree of priority is carried out. As in the above processing, the write control and read control are executed with reference to information of the remainder counter 4-6, memory empty space management bit 4-3, memory bank information 4-4, and valid bit 4-5.

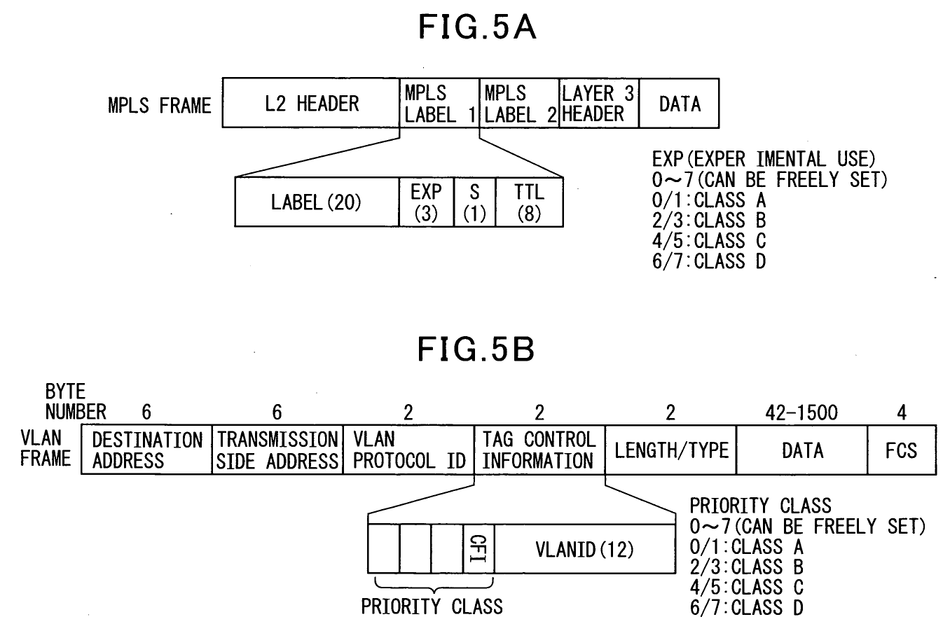

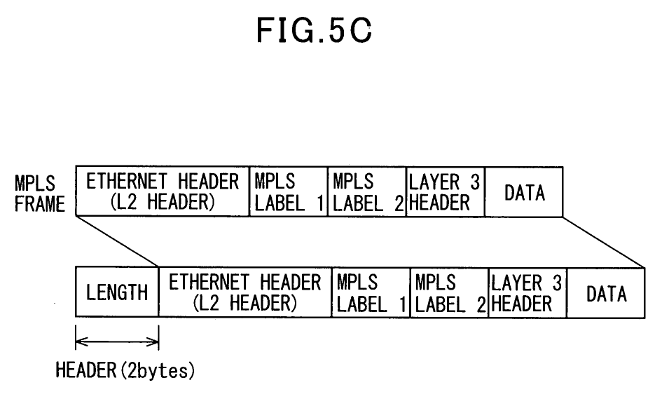

A specific example of the class judgment in the class discriminator 4-1 is shown in FIGS. 5A to 5C. FIG. 5A shows a specific example of the class judgment in an MPLS frame. The EXP (Experimental Use: 3 bits) of the MPLS label 1 in the MPLS frame can be freely defined. It can be defined as in for example the following way.

0/1: Class A, 2/3: Class B, 4/5: Class C, 6/7: Class D.

Note that in the MPLS frame, S (Bottom of Stack) is a field indicating the last label in the label stack, “S=0” indicates that labels follow, and “S=1” indicates the last label in the label stack. TTL (Time to Live) indicates a remaining lifetime of this packet. This value is decremented whenever it passes through a router up to the destination of the network. The packet is discarded when the value becomes 0.

FIG. 5B shows a specific example of the class judgment in an Ethernet® VLAN frame. Tag control information of the VLAN frame includes 3 bits indicating the degree of priority. For example, the priority can be defined as follows by using this bit. 0/1: Class A, 2/3: Class B, 4/5: Class C, 6/7: Class D.

Note that, in the above frame, “CFI” is a canonical format indicator (“0”: little endien, “1”: big endien). At present, it is a field for writing a DSCP value of DiffServ. “VLANID” is a VLAN ID number. This VLANID is used to recognize a specific user and perform routing to the destination. However, the present invention is not limited to an MPLS frame or VLAN frame etc. and may employ a configuration using a bit of another frame format for the class judgment.

Further, a specific example of designation of the length value of the internal processing frame in the present invention is shown in FIG. 5C. The frame discriminator 4-1 discriminates the length value (length) of the received frame and, as shown in FIG. 5C, stores the length value in the header. This is used in order for the scheduler to recognize the length of data read out from the memory 4-7 in the embodiment mentioned later. By storing the length value as the header in the frame in this way, it becomes possible for the scheduler to read out data having any frame length.

A specific example of the operation of the present invention will be explained next. The following example of operation is an example of operation when partitioning the memory into six areas as a first example of the configuration. The memory may be partitioned into any number of areas, but in the case of partitioning it into six, memories for {memory bank information (3 bits)+valid bit (1 bit)}×6 (number of partitions)×4 (classes)=96 bits of management information and for the memory management bit (1 bit) indicating presence of a memory bank×6 (number of partitions)=6 bits become necessary. These fluctuate according to the number of partitions.

As another configuration, when partitioning the memory into for example 10 areas, memories for {memory bank information (4 bits)+valid bit (1 bit)}×10 (number of partitions)×4 (classes)=200 bits and for a memory management bit (1 bit) indicating presence of memory×10 (number of partitions)=10 bits become necessary.

The data of the write address controller (Wadr_ctr) 4-7 and the data of the read address controller (Radr_ctr) 4-9 require a number of bits for indicating the address space of the entire memory. For example, assuming that each memory bank writes one word (=32 bits) of data into each address and each memory bank has the capacity of 5 Mbits, each memory bank has an address space of 156250 as apparent from the following equation.

5 Mbits*1 word(=32 bits)=156250

Each of the six memory banks has an address space of 156250, therefore the address space of the entire memory becomes 937500 (=156250×6). Because 937500 (dec)=E4E1C (hex), 20 bits become necessary in order to represent the address space of 937500.

The remainder counter needs a number of bits enabling count of the number of frames when frames having the minimum frame length are stored in the entire memory until it is full. Assuming that the minimum frame length of 1 frame is 64 bytes, since 64 bytes correspond to 16 words, 58594 (=937500÷16) becomes the maximum number of frames able to be stored in the entire memory. Because 58594 (dec)=E4E2 (hex), the counter for counting 58594 frames may be a counter of 16 bits.

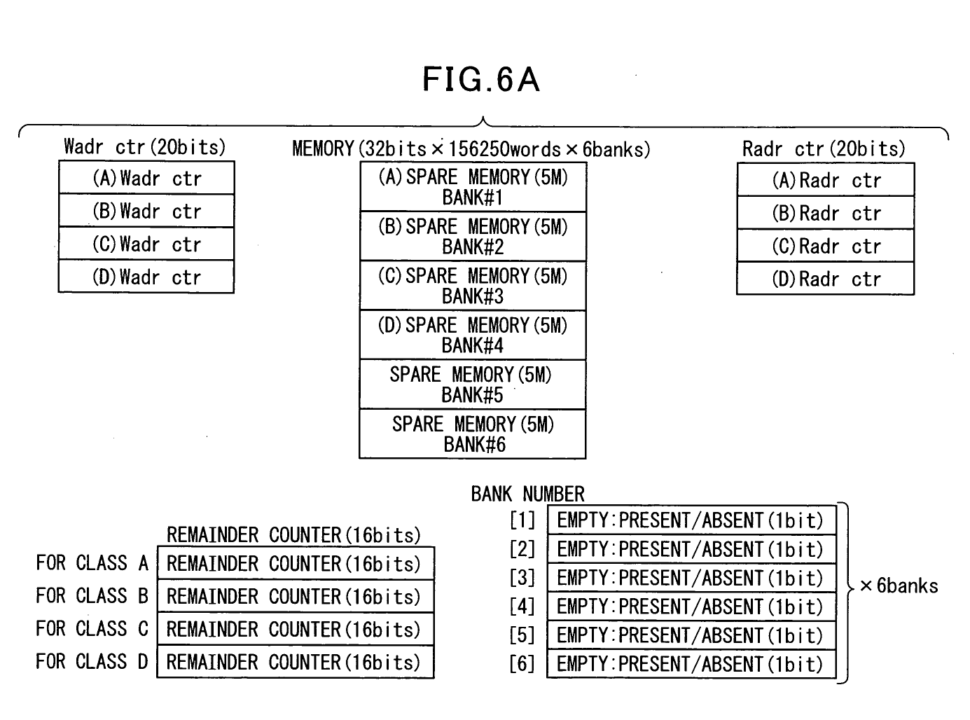

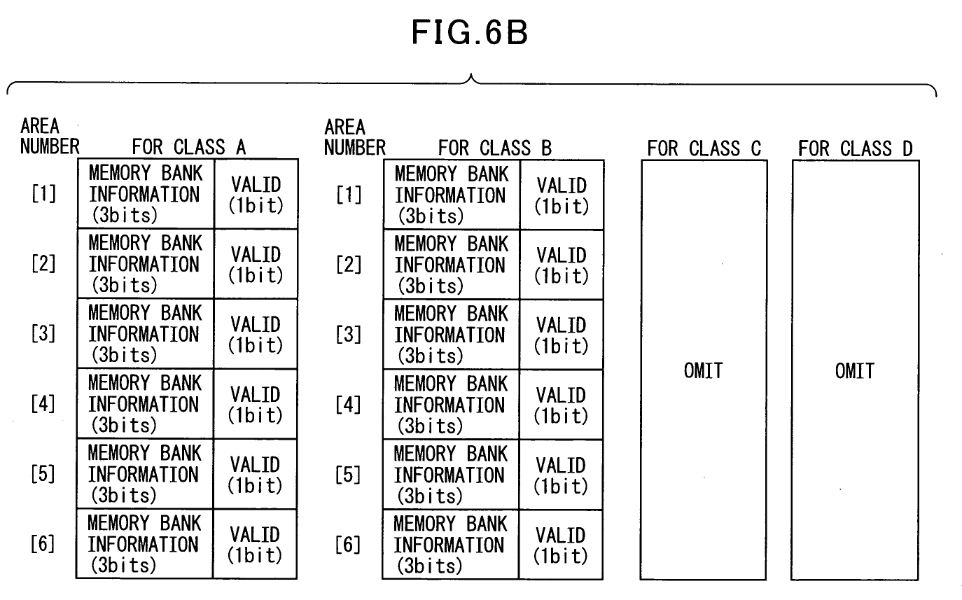

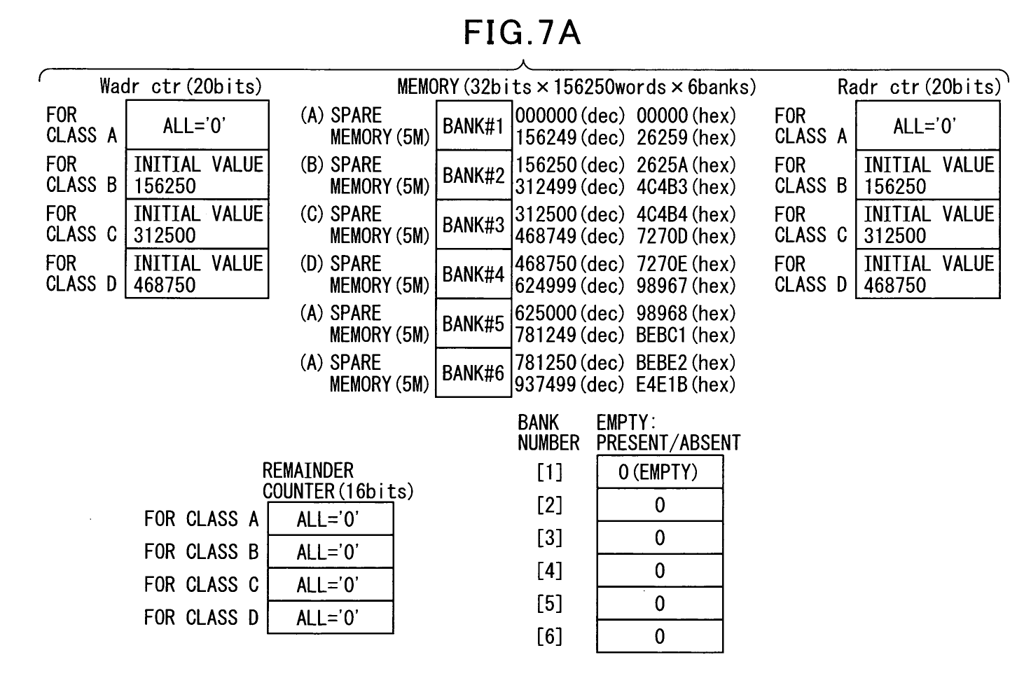

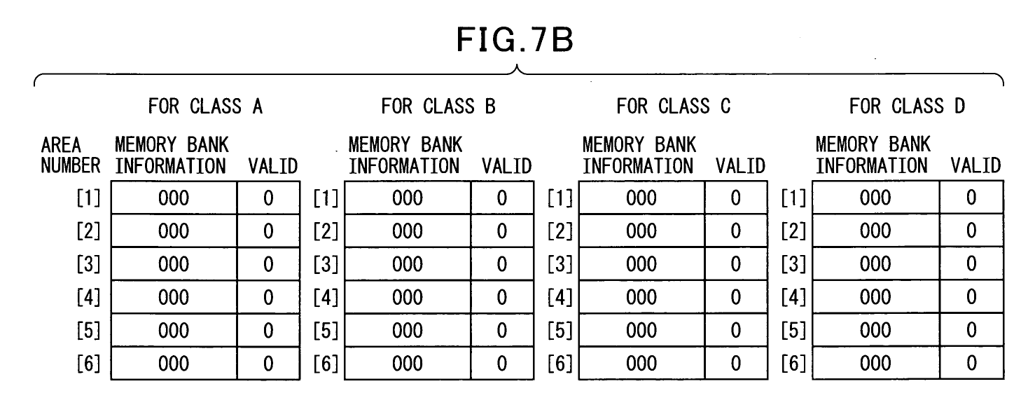

FIGS. 6A and 6B show the data configuration of each memory in the first example of configuration of the present invention. FIGS. 7A and 7B show the initial state of each memory. There is no particular restriction or limitation with respect to the initial state, but each of the initial states of the write address controller (Wadr_ctr) and the read address controller (Radr_ctr) is set by default so that the data of classes A, B, C, and D are stored in the memory banks #1, #2, #3, and #4. Here, an explanation is given assuming that the operation starts from such an initial state, but the present invention is not limited to this.

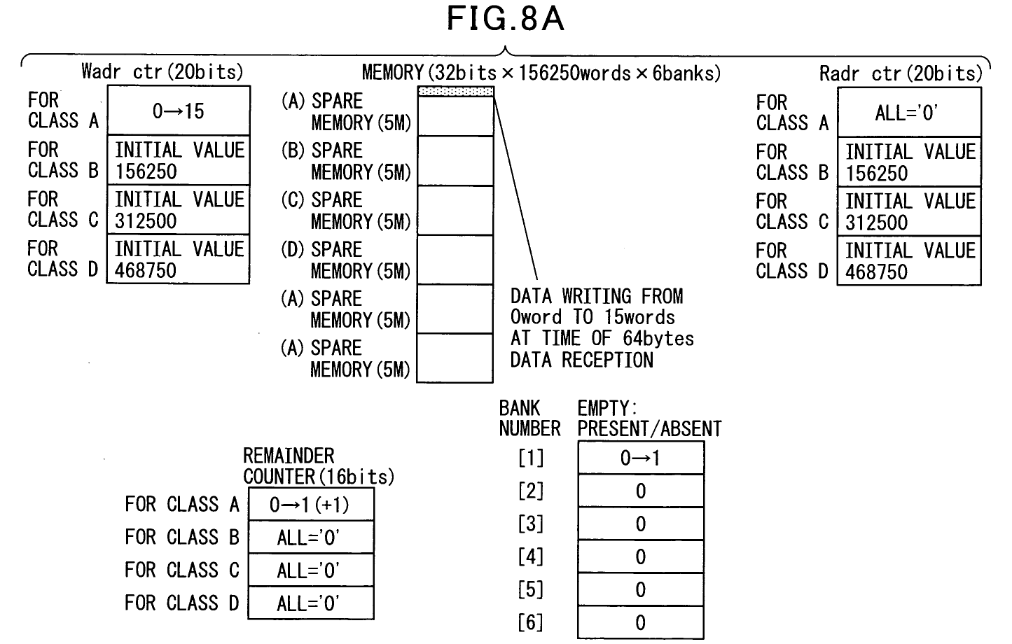

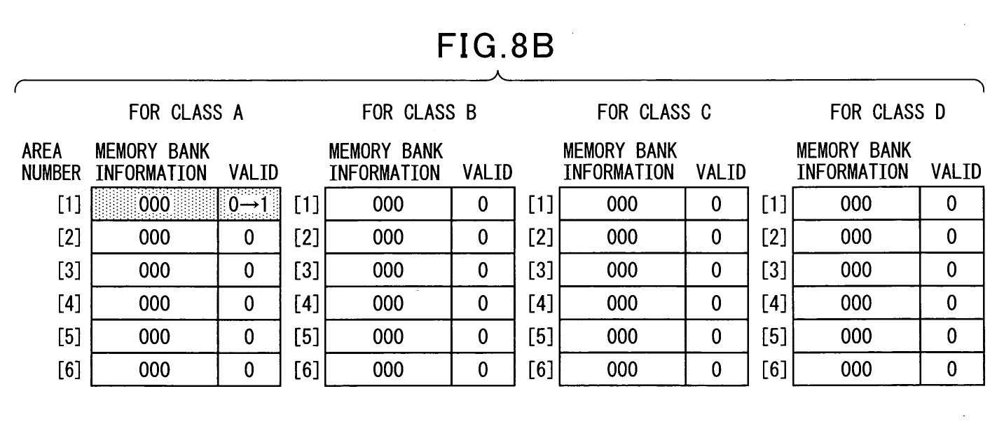

First, as a first case, the state of completion of an operation for receiving and writing 64 bytes of data of the class A is shown in FIGS. 8A and 8B. In this example of operation, 4 bytes×16 addresses worth of data is written into the memory bank #1, therefore the write address controller (Wadr_ctr) increments the count from 0 to 15.

Further, the remainder counter (16 bits) of the class A is incremented by only “1”, and the memory empty space management bit indicating the presence of empty space of the memory bank #1 is set at “1” (=no empty space). Further, as the first area for storing the data of the class A, the memory bank information “000” indicating the memory bank #1 and the valid bit “1” indicating that the valid data is stored in that area are set.

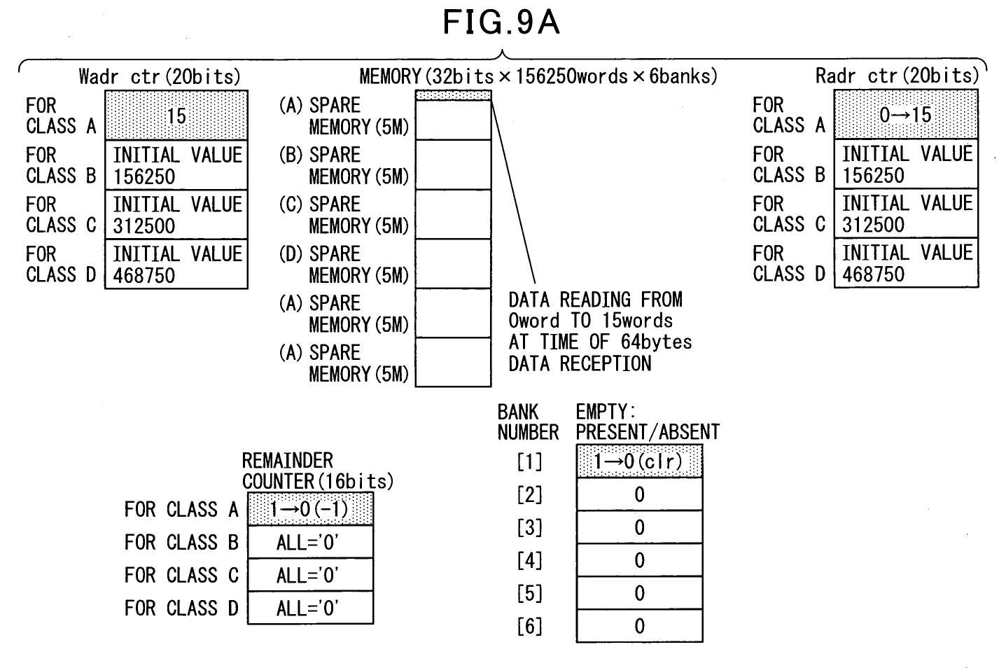

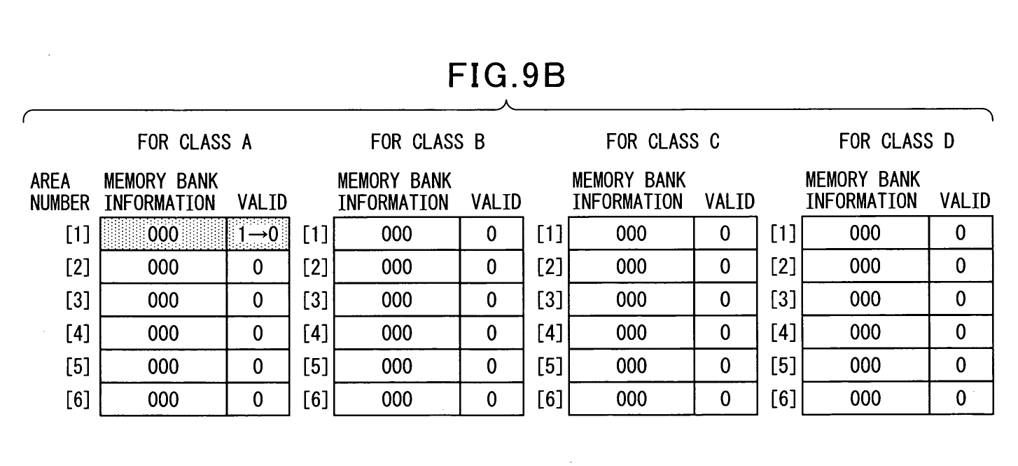

Next, as a second case, the state of completion of an operation for receiving and writing 64 bytes of data of the class A after the operation of the first case described above is shown in FIGS. 9A and 9B. The read controller recognizes that the count of the remainder counter of the class A with the highest priority is “1” and starts the processing for reading the data of the class A from the memory.

The read controller refers to the memory bank information “000” of the first area and increments the count of the read address controller (Radr_ctr) address from 0 to 15 and sequentially reads out the data so as to read out the data of the class A from the memory bank #1. When finishing reading all of the data, it returns the valid bit “1” of the first area to “0”, sets the value of the remainder counter (16 bits) from 1 to 0, and makes the memory management bit indicating the presence of empty space “0” (empty space exists). In this way, the write processing and read processing of data are carried out with respect to 1 frame of received data.

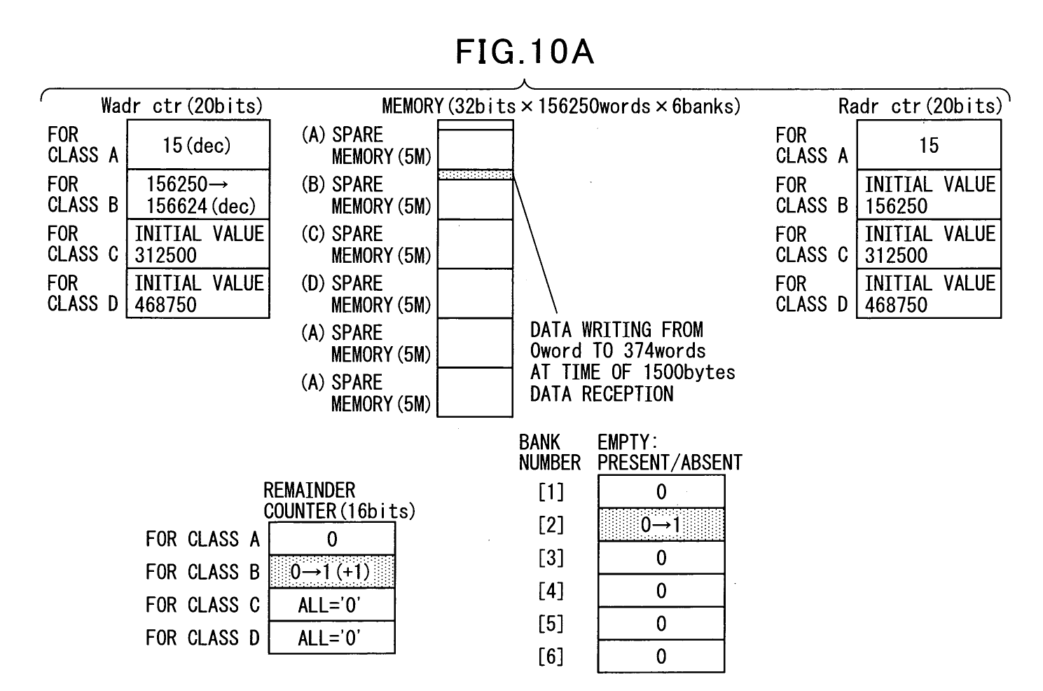

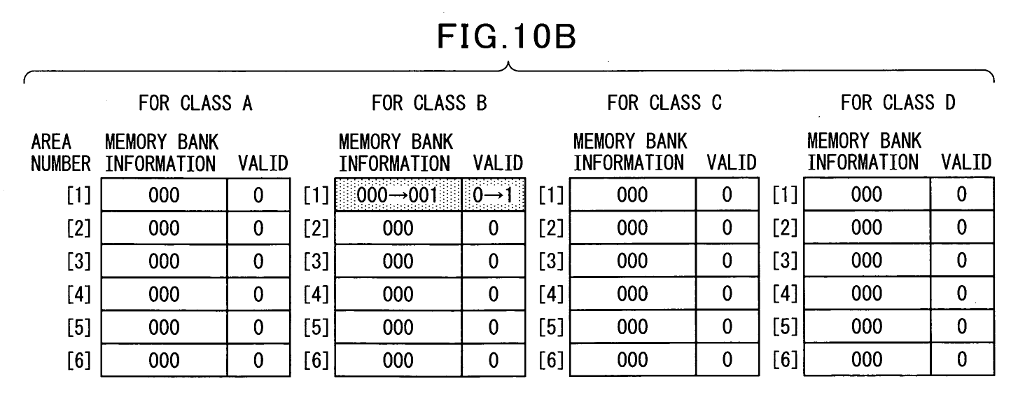

Next, as a third case, the state of completion of an operation for receiving and writing 1500 bytes of data of the class B is shown in FIGS. 10A and 10B. When it is recognized that the received frame is the class B, “001” indicating the bank #2 assigned by default as the first area is written into the memory bank information of the class B, and the valid bit thereof is set at “1”.

The counter of the write address controller (Wadr_ctr) of the class B counts 1500 bytes (1500÷4=375) worth of addresses from the initial value 156250 whereby the value becomes 156624 (=156250+375−1). The basic operation is the same as the processing operation in the class A mentioned before (first case).

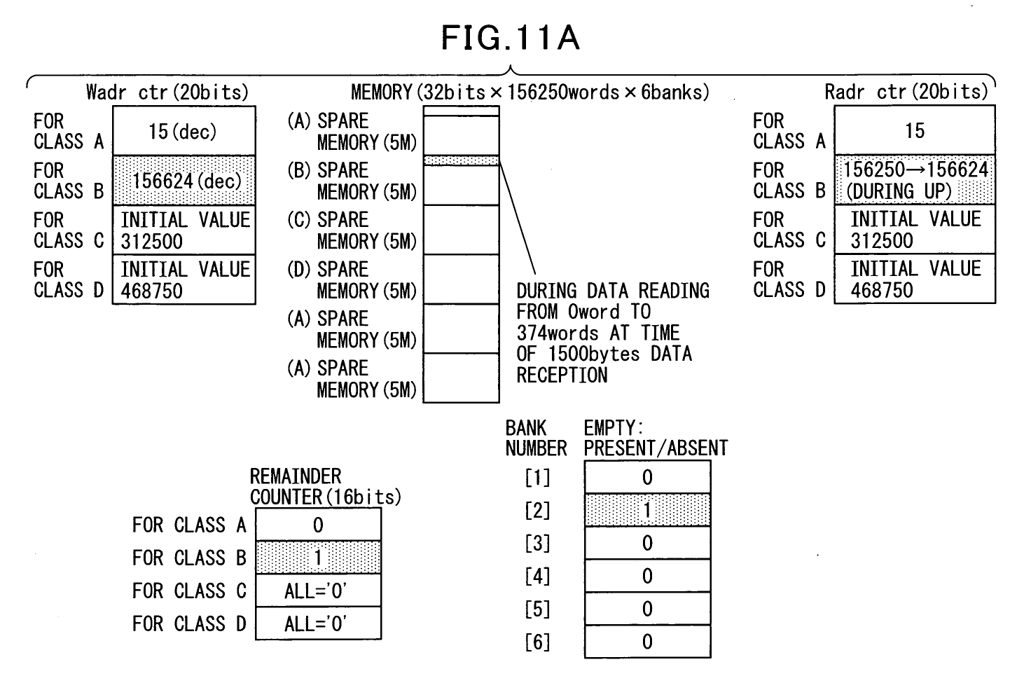

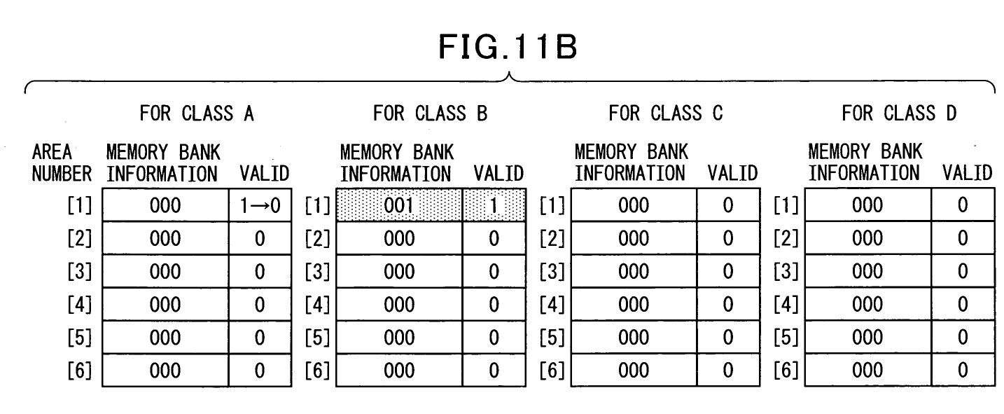

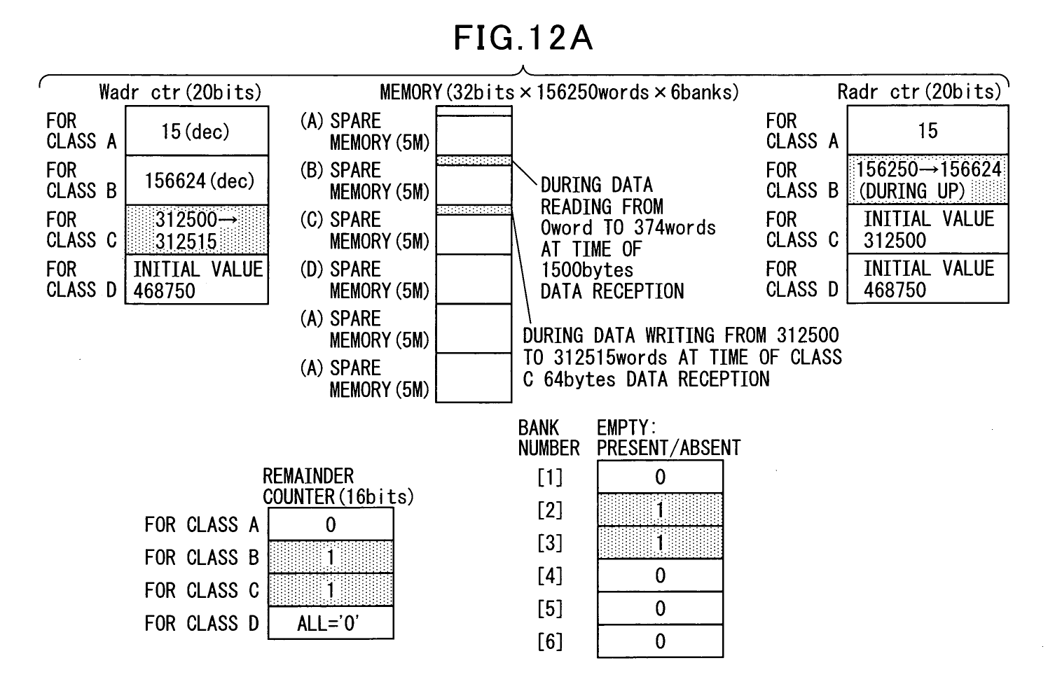

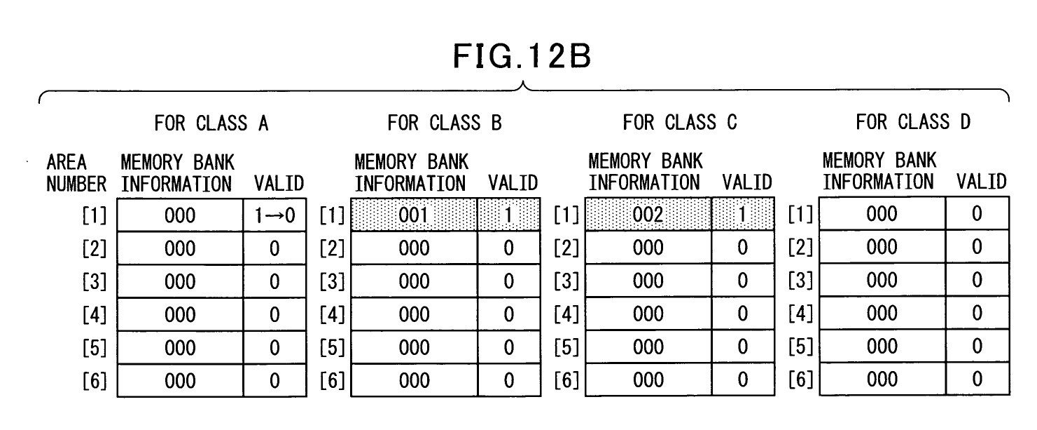

As a fourth case, the state of completion of an operation for receiving and reading 1500 bytes of data of the class B is shown in FIGS. 11A and 11B. The address controller (Radr_ctr) of the class B counts from 156250 to 156624 in the same way as the third case mentioned before. In the middle of this operation, as a fifth case, FIGS. 12A and 12B show the state of completion of an operation for receiving and reading 1500 bytes of data of the class B and then an operation for receiving and writing 64 bytes of data of the class C.

In the fifth case, when reading the data of the class B, the data of the class C is written. The 64 bytes of write data are small in amount of data in comparison with 1500 bytes of the read data, therefore this processing of writing is completed earlier in this example of operation. The counter value etc. become the state shown in the figure.

The state where the data of the class B is stored in the memory bank #2, and the data of the class C is stored in the memory bank #3 is shown. The write operation and the read operation are independently processed in this way, therefore the write processing of the data into the memory bank is possible while reading the data from the memory bank.

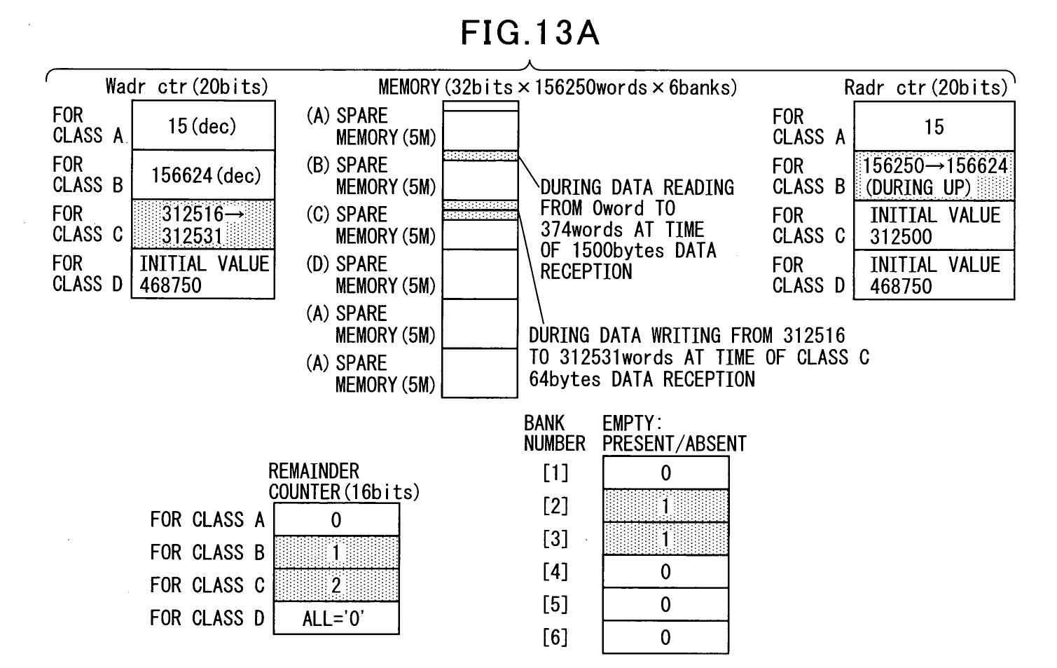

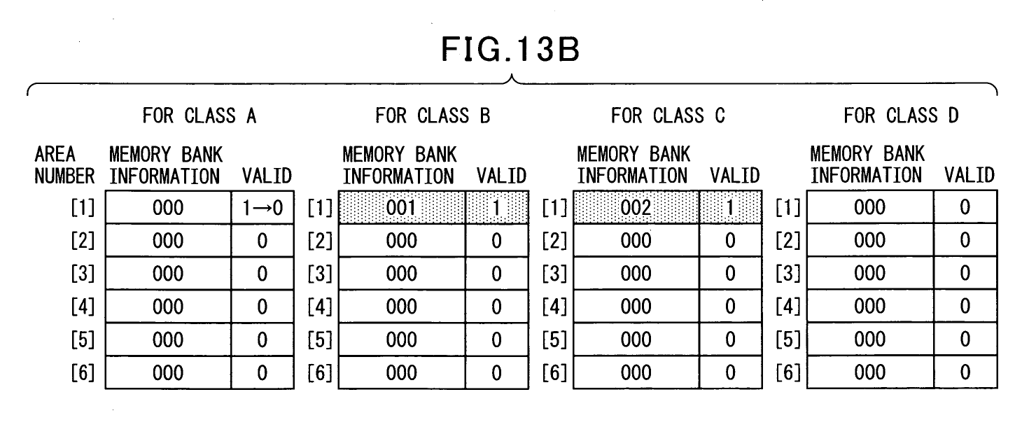

Further, as a sixth case, the state of completion of an operation for receiving and writing 1500 bytes of data of the class B and a second operation for receiving and writing 64 bytes of data of the class C is shown in FIGS. 13A and 13B. The read processing of 1500 bytes of data of the class B becomes long in processing time in comparison with the 64 bytes of data, therefore the state where 2 frames' worth of 64 bytes of data of the class C is written after the above fifth case is shown.

For this reason, the value of the remainder counter of the class C becomes 2. The memory bank information of the class C is “002” indicating the memory bank #3, and the valid bit thereof is in the state of “1”. Note that, the data length such as 1500 bytes is recognized by referring to the data length information stored in the header of the frame. The read controller reads out any frame length.

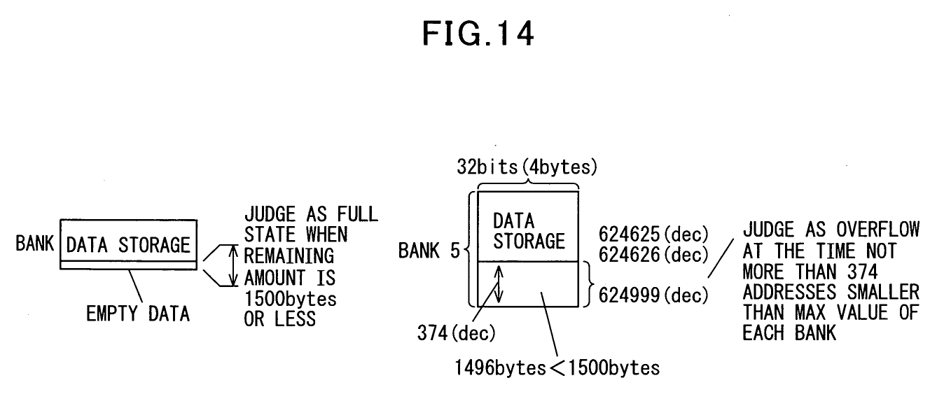

FIG. 14 shows an example of the technique for judgment of the full state of a memory bank. If the maximum frame length is for example 1500 bytes, when the empty area of one memory bank becomes less than 1500 bytes, the bank is deemed full and the next received frame is written into another empty memory bank.

For example, the overall address space of the memory bank #4 is 468750 to 624999. When data is stored in 468750 to 624625 of that, the addresses of the remaining area become 624626 on, and the address space of the empty area becomes 374 or less, the memory bank #4 is deemed to be full.

This is because 4 bytes of data are stored at 1 address, the above 374 address space can only store a frame up to 1496 bytes (=374×4 bytes), and, when a frame of the maximum length, that is, a frame of 1500 bytes, is received, that empty area cannot store all of the frame data, therefore, when the empty area becomes less than the maximum frame length, the memory bank is deemed full. By setting this, the storage of one frame separated into a plurality of memory banks is prevented, and the address control by the write address controller (Wadr_ctr) and the read address controller (Radr_ctr) can be more simplified.

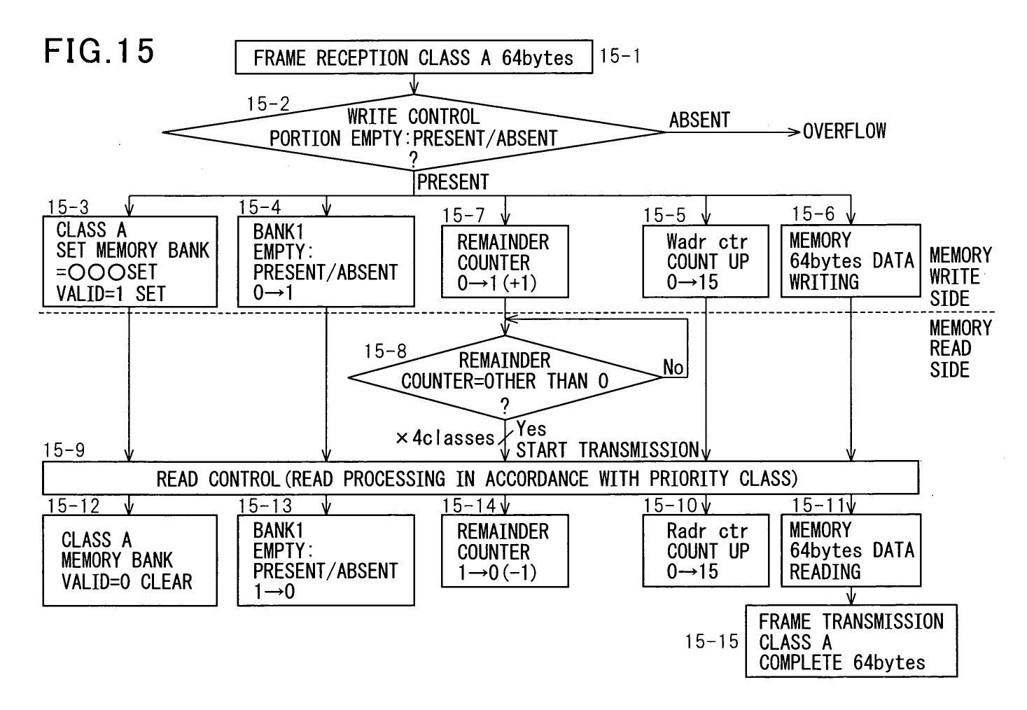

FIG. 15 shows the flow of processing of the basic operation at the time of receiving 64-byte frames of the class A. When receiving the first frame of the class A (step 15-1), the write controller judges the presence of empty space of the memory bank based on the memory empty space management bit (step 15-2), sets the discrimination information “000” of for example the empty memory bank #1 in the first area of the memory bank information of the class A when there is an empty space, sets “1” at the valid bit of that area (step 15-3), sets “1” indicating congestion at the memory empty space management bit of the memory bank #1 (step 15-4), increases the counts at the write address controller (Wadr_ctr) (0→15) (step 15-5), writes the frame data into the memory bank #1 (step 15-6), then adds 1 to the remainder counter of the class A and sets it at 1 (step 15-7).

In the read processing, it is confirmed whether or not the value of the remainder counter of the class A is other than 0 (step 15-8). When it is other than 0, the read processing of the data of the class A is started (step 15-9). The remainder counter is provided for each class. The remaining count thereof is confirmed from the class having the highest degree of priority, then the read processing is started. The count up (0→15) of the read address controller (Radr_ctr) is carried out for the class A (step 15-10), the data is read out from the memory bank #1 (step 15-11), then the transmission of that data is started.

When finishing reading 64 bytes of data of the class A, the memory bank information of the class A is cleared and the valid bit is cleared (“1”→“0”) (step 15-12), the memory empty space management bit of the memory bank #1 is set at “0” (empty) (step 15-13), the remainder counter of the class A is changed from 1 to 0 (step 15-14), and the transmission of the frame is completed (step 15-15).

Basically the write processing and the read processing are carried out in this way. The operation is the same even when frame lengths are different. Further, the write processing and the read processing independently operate. For the write processing, the write processing is carried out when there is empty space in the memory bank. For the read processing, the read processing is started when the remainder counter is other than 0.

In the above operation, when the same degree of bandwidth is secured for the output as with the bandwidth of the input, the memory never keeps just the data of the received frames. However, the data output from the scheduler sometimes stops being read according to the state of the destination of connection thereof.

For example, this happens when the channel of the destination of connection is congested or when a fault occurs. In such cases, the data stops being read from the memory. Data is only written into the memory. Therefore, the data begins to gradually build up in the memory. Below, the operation when the data begins to be stored in the memory and the write controller writes the data of one class over a plurality of memory banks will be explained.

Here, if the maximum length of an input frame is for example 1500 bytes, when the remaining space of a memory bank becomes 1500 bytes or less, it is judged that the memory bank is full and control is performed to write the data into the next memory bank. This can be automatically judged on the basis of the write address.

The following example is an explanation given relating to the memory bank #4. As explained in FIG. 14, when the write address becomes 624626 or more in the memory bank #4, even if new frame is received, it is judged that the memory bank #4 would overflow, so the write operation into the memory bank #4 is stopped. While the explanation is omitted, this is also true for the other memory banks.

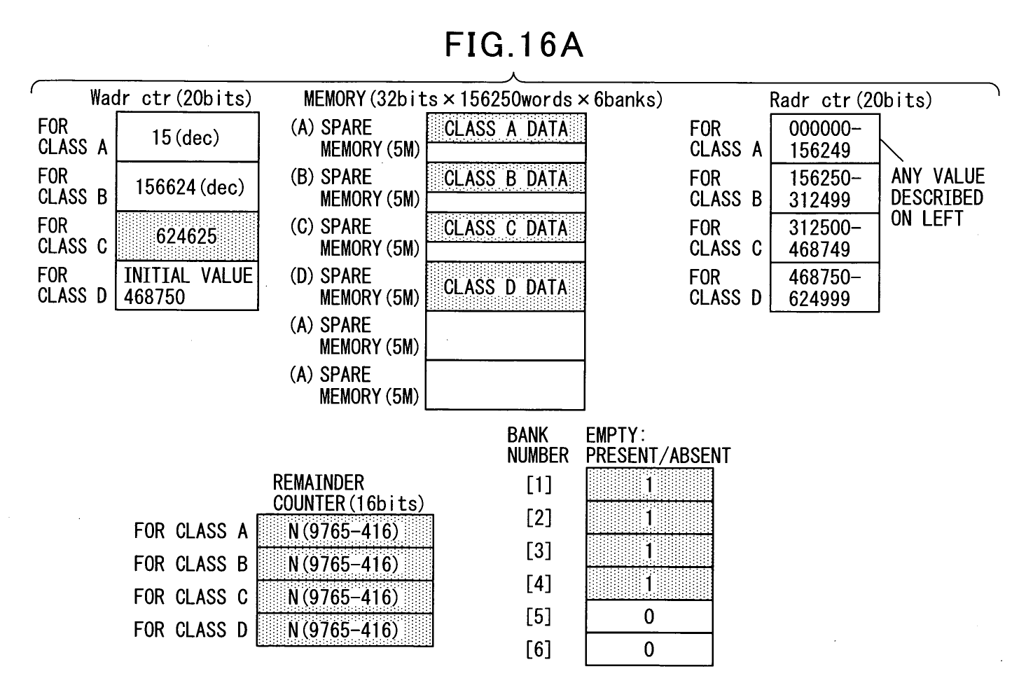

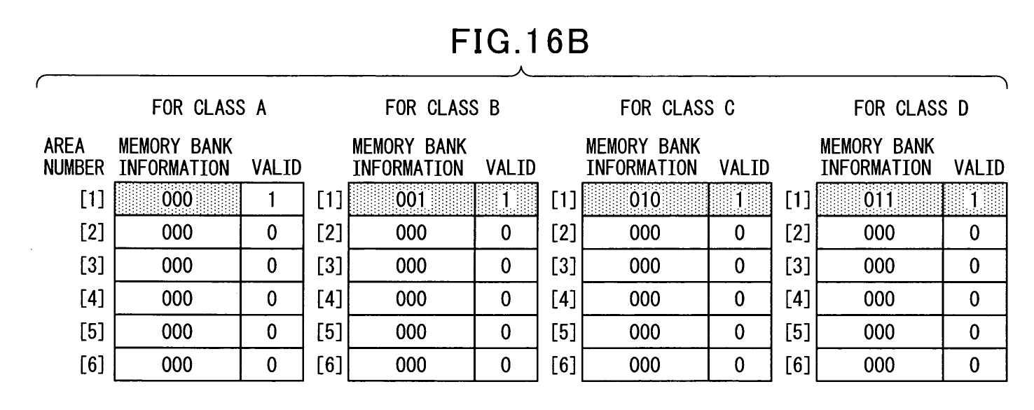

FIGS. 16A and 16B show a state where data are stored in the memory bank #1 (class A), the memory bank #2 (class B), the memory bank #3 (class C), and the memory bank #4 (class D) and the memory bank #4 (class D) is full. The read address controller (Radr_ctr) assigns a range from 000000 to 156249 to for example the class A. This method of description is employed in order to be able to indicate the address value of any address space since the data may be written up to any address space of the memory bank #1.

Further, in the remainder counter as well, the count differs according to the frame length—which changes between the minimum frame length of 64 bytes and the maximum frame length of 1500 bytes, therefore a value within a range from the count 9765 (=5 Mbits÷64 bytes) in the case of all 64-byte length (min) frames to a count 416 (=5 Mbits÷1500 bytes) in a case of all 1500-byte (max) frames becomes the number of frames stored in one memory bank. Here, assuming that N number of memory banks are used to store the frames, the number of all frames becomes a number from N×416 to 9765.

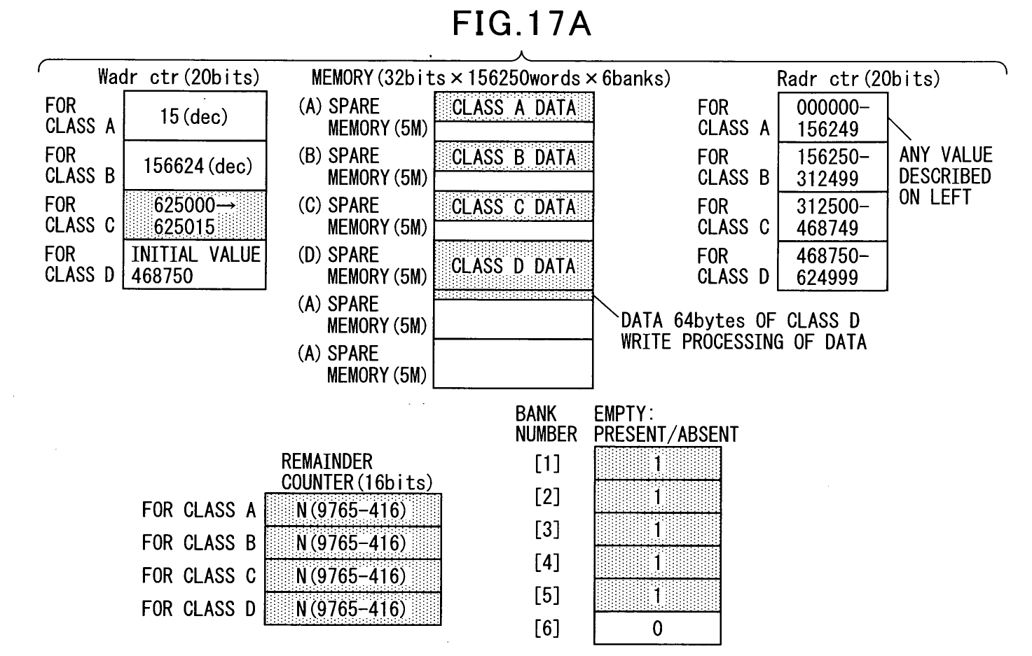

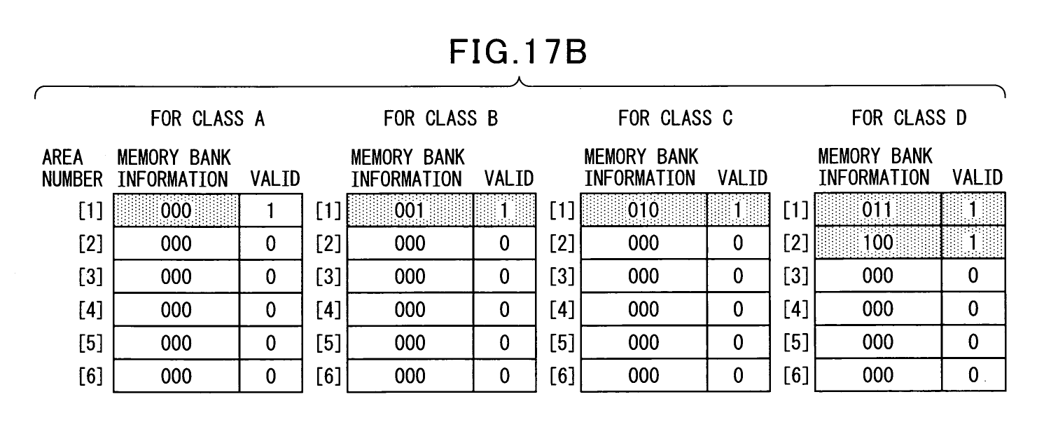

Next, FIGS. 17A and 17B show a state where 64 bytes of data of the class D are newly received after the state of FIGS. 16A and 16B, the discrimination information “100” of the memory bank #5 and the valid bit “1” thereof are newly set in the second area of the memory bank information for the class D, and the memory management bit “1” indicating the state of no empty space is set for this memory bank #5.

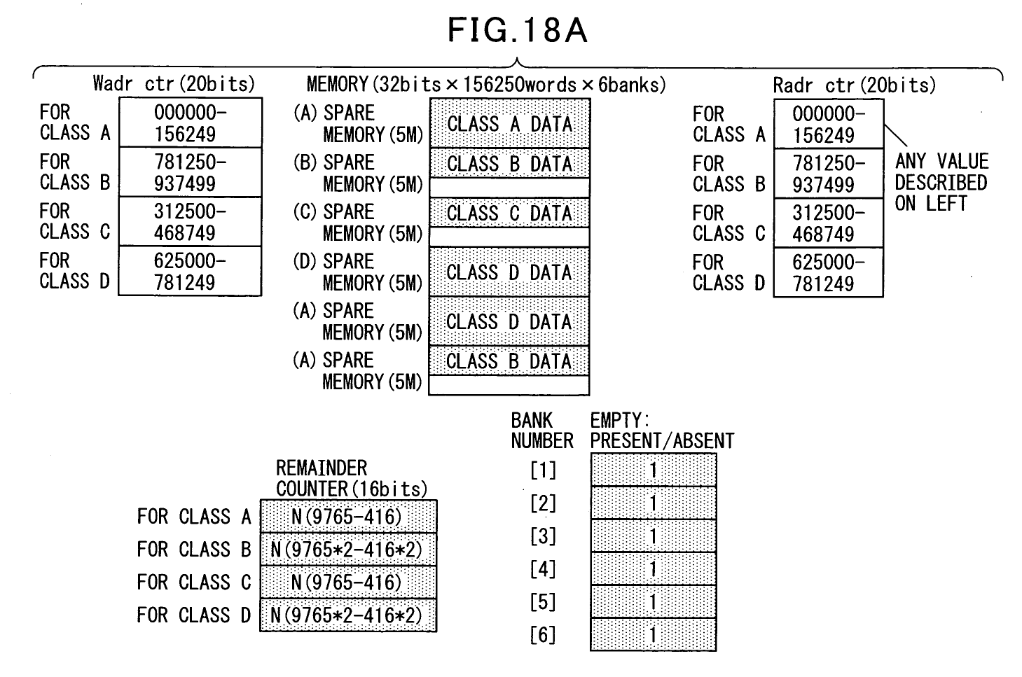

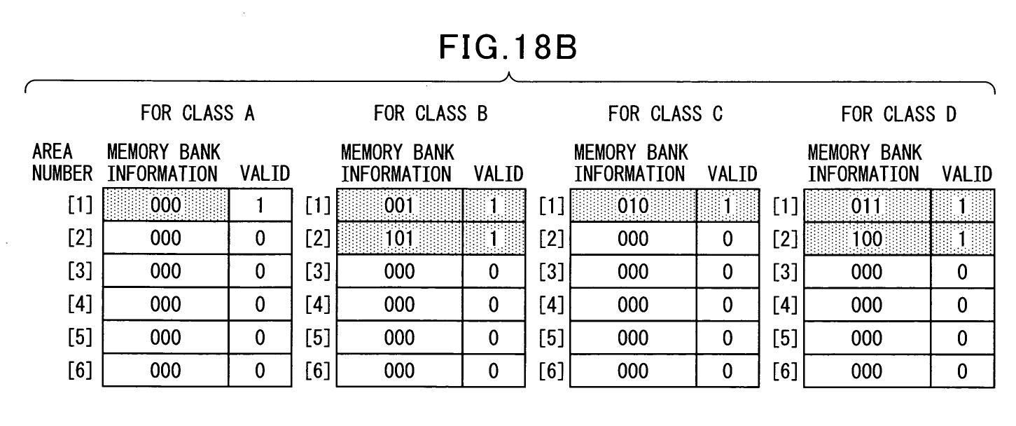

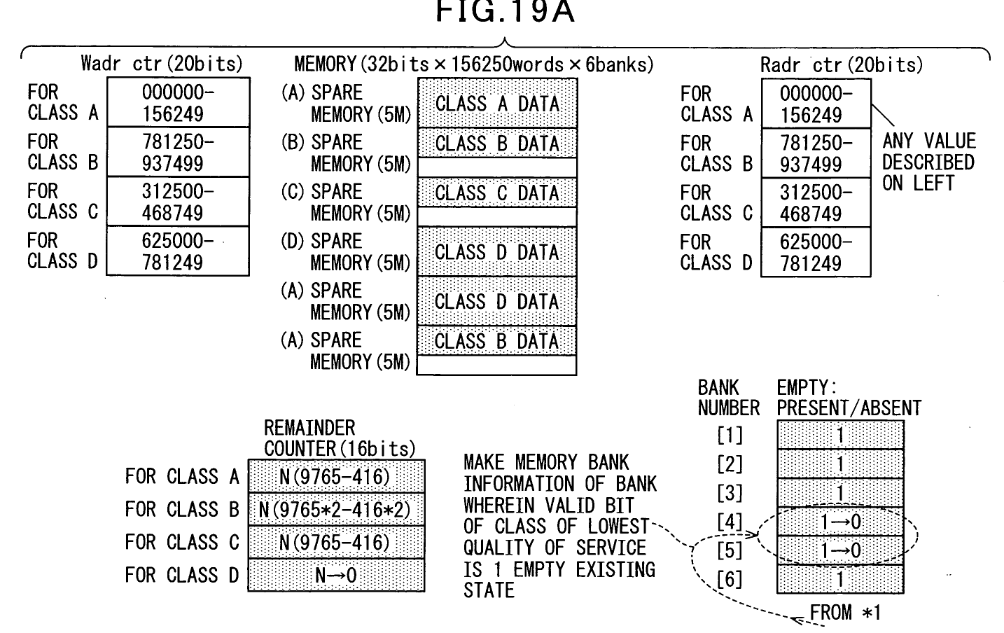

Next, the writing and discarding of data of the memory in accordance with the degree of priority will be explained. FIGS. 18A and 18B show an example of operation when data of lower degree of priority which has been already stored inside the memory is discarded when data of a higher degree of priority is input, and the higher priority data is written over the data storage area of the lower degree of priority. The figure shows a state where the memory bank #1 (class A) is full, while data are individually stored in the memory bank #2 (class B), the memory bank #3 (class C), the memory bank #4 (class D), the memory bank #5 (class D), and the memory bank #6 (class B).

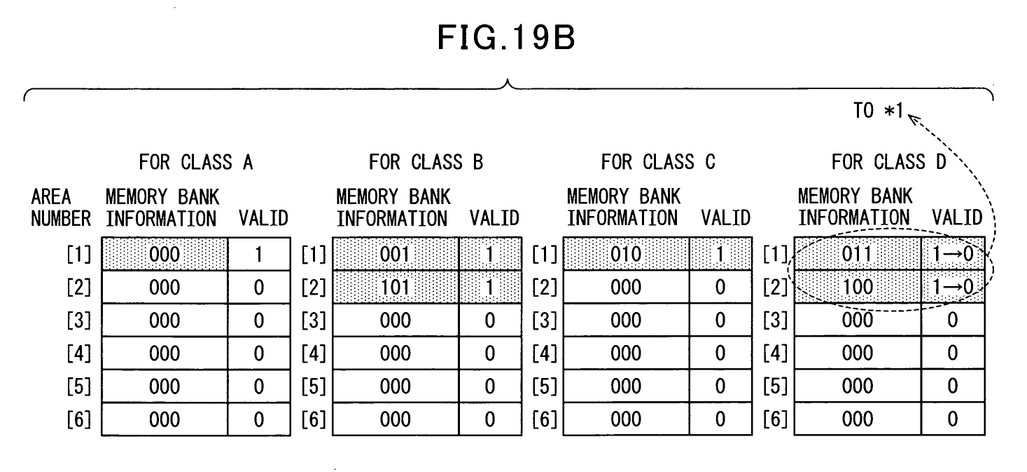

FIGS. 19A and 19B show the state of operation when receiving 64 bytes of data of the class A after the state of FIGS. 18A and 18B. When receiving 64 bytes of data of the class A after the state of FIGS. 18A and 18B, there is no memory bank able to write the data of the class A, therefore the data of the lowest degree of priority in comparison with the degree of priority of the received data and the degree of priority of the already written data is discarded.

In this example of operation, the data of the memory banks #4 and #5 in which the data of the class D are written are discarded. Then, valid bits of the first and second areas corresponding to the memory banks #4 and #5 of the memory bank information of the class D are cleared to “0”, bits of the memory banks #4 and #5 in the memory empty space management bit are cleared to “0”, and the remainder counter for the class D is cleared to 0. In this way, the memory bank in which the valid bit of the class having the lowest degree of priority becomes “1” is returned to the state with empty space.

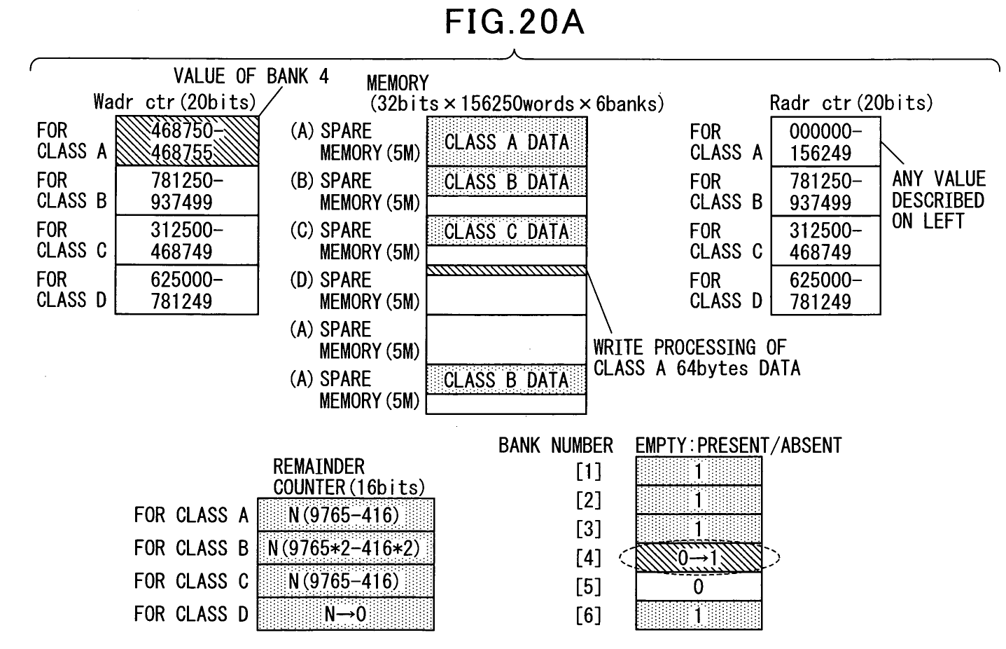

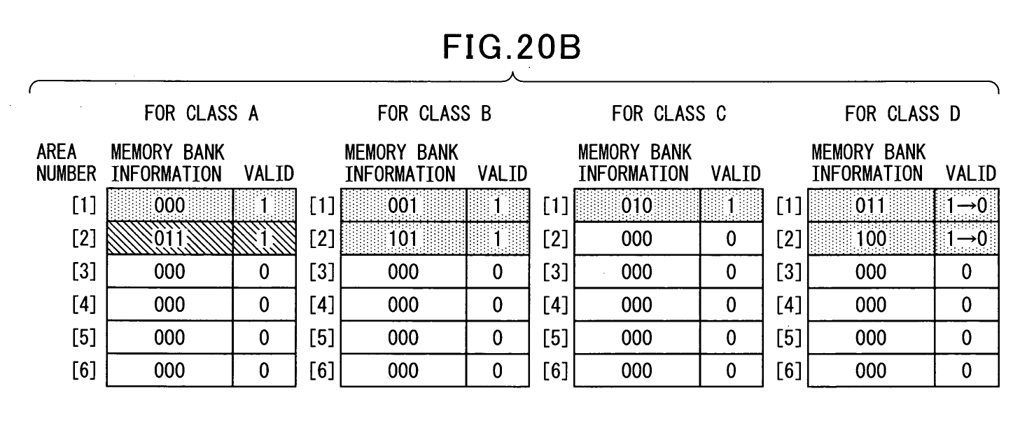

FIGS. 20A and 20B show the state of operation when further receiving 64 bytes of data of the class A after the state of FIGS. 19A and 19B. The address of the memory bank #4 is counted up from 468750 to 468765 by the write address controller (Wadr_ctr) of the class A after the state of FIGS. 19A and 19B, the data of 64 bytes is written into the memory of the memory bank #4, “011” indicating the memory bank #4 and its valid bit “1” are set in the second area of the memory bank information of the class A, and the memory empty space management bit of the memory bank #4 is set at “1”.

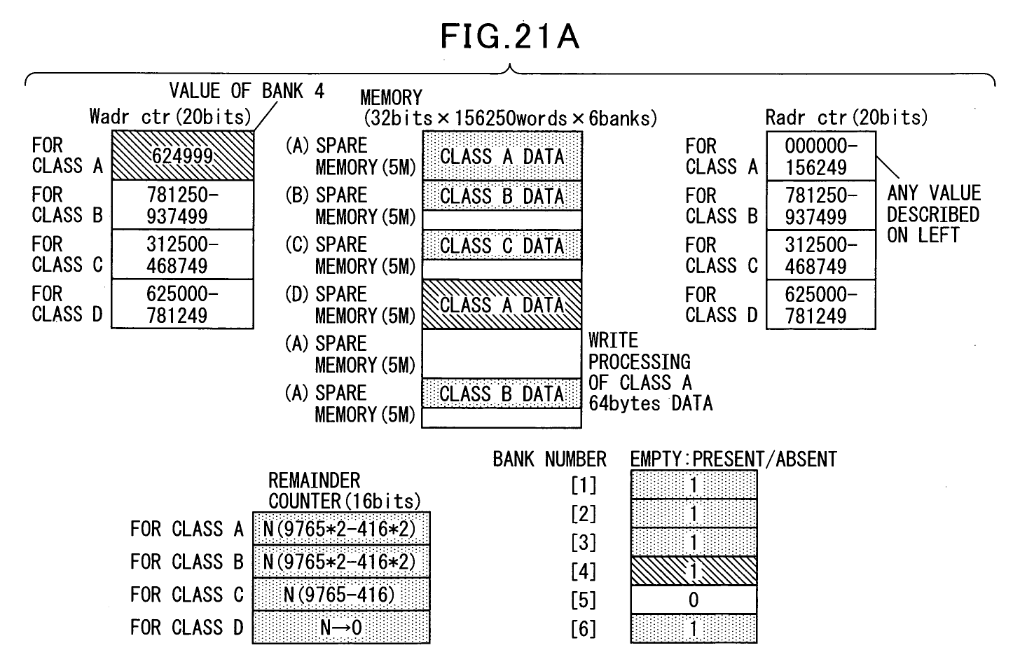

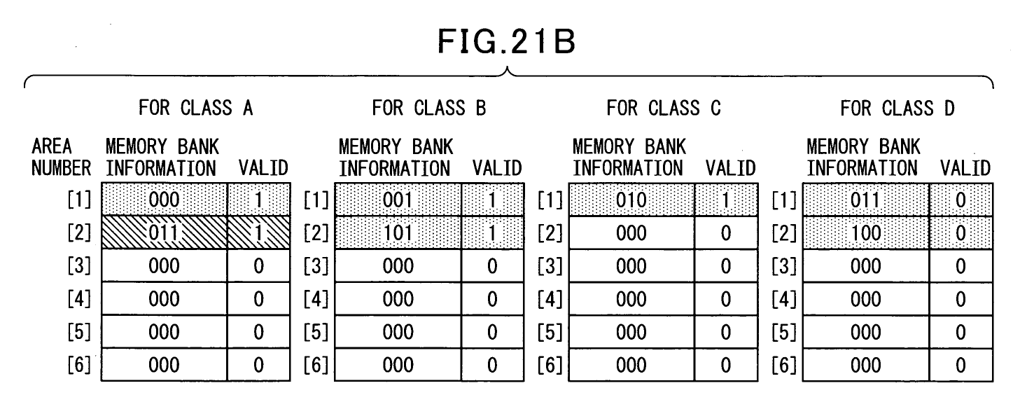

FIGS. 21A and 21B show a state where the write processing of the data of the class A is executed up to the full state of the memory bank #4. A state where the address value of the write address controller (Wadr_ctr) is counted up to 624999 (maximum address value of the memory bank #4) is exhibited.

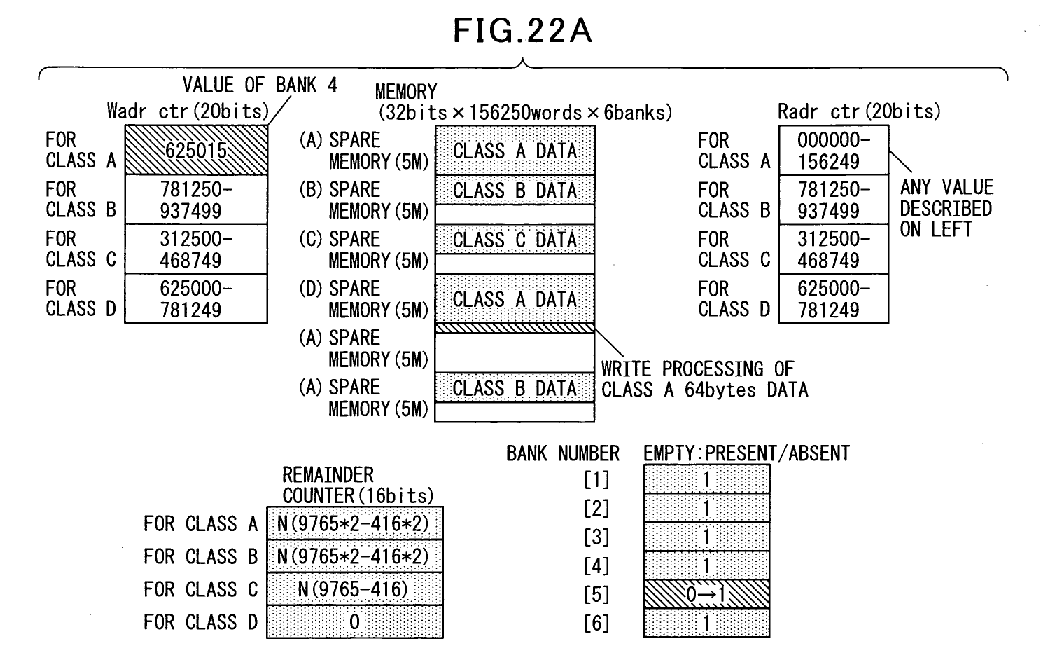

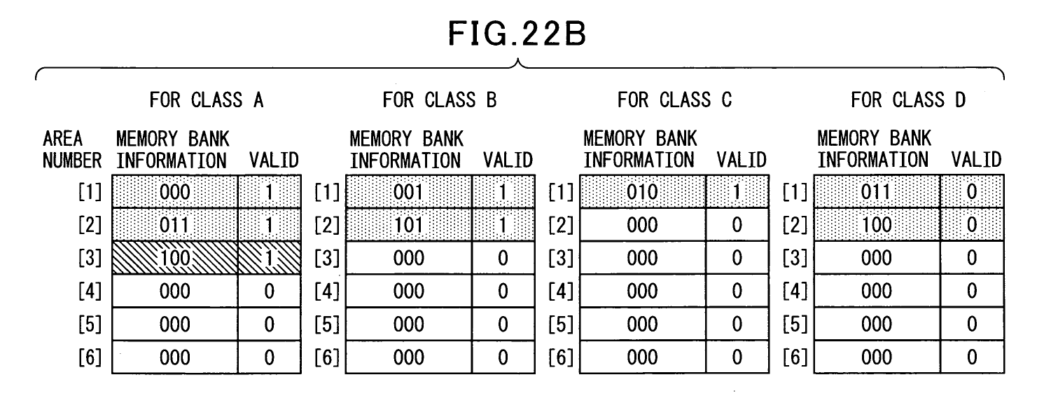

FIGS. 22A and 22B show a state where processing for further receiving 64 bytes of data of the class A and writing the data of the class A into the memory bank #5 is executed. The write address controller (Wadr_ctr) counts up the address of the memory bank #5 from the header address 625000 to 625015. Further, “100” indicating the memory bank #5 is set in the third area of the memory bank information of the class A, the valid bit thereof is set at “1”, and the memory empty space management bit of the memory bank #5 is set at “1”.

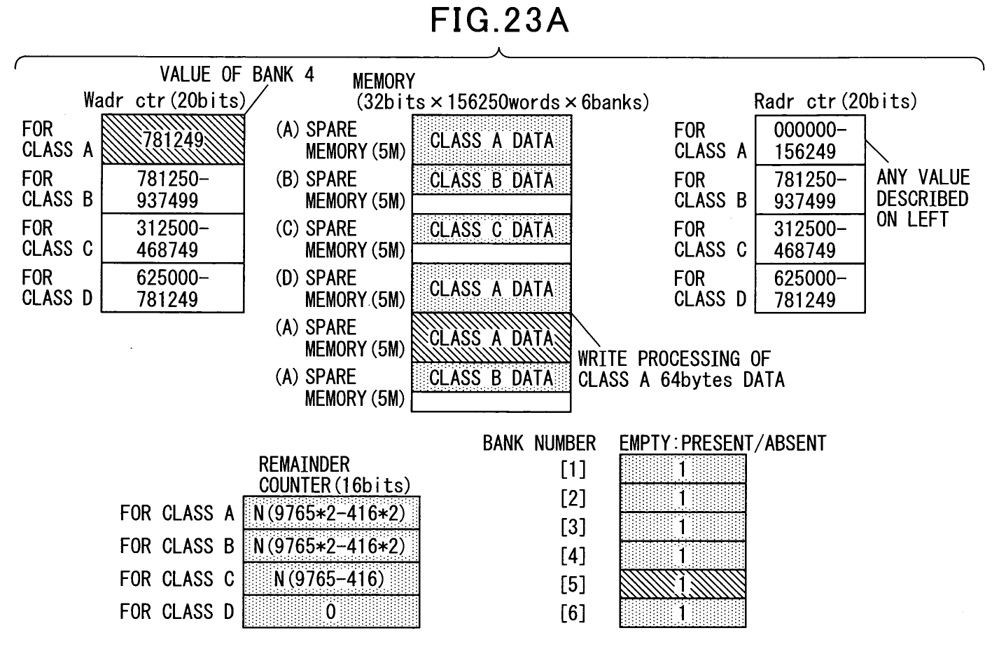

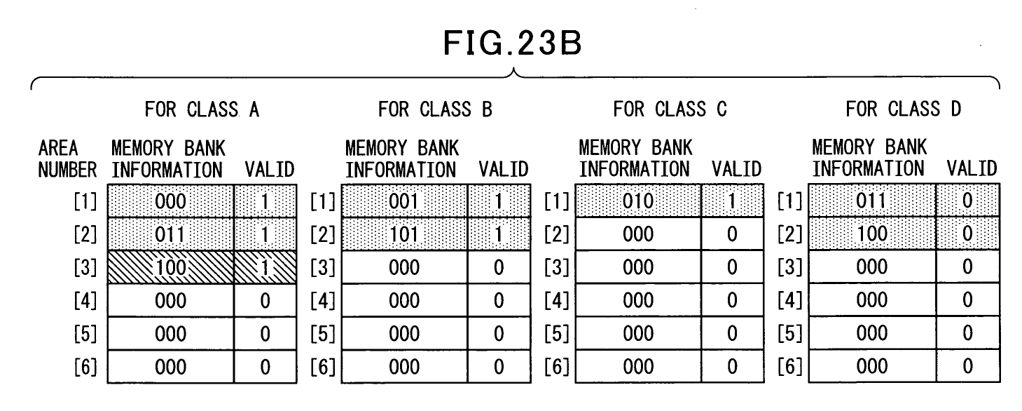

FIGS. 23A and 23B show a state where the write processing of the data of the class A is carried out up to the full state of the memory bank #5. The value of the write address controller (Wadr_ctr) becomes 781249 as the last address of the memory bank #5.

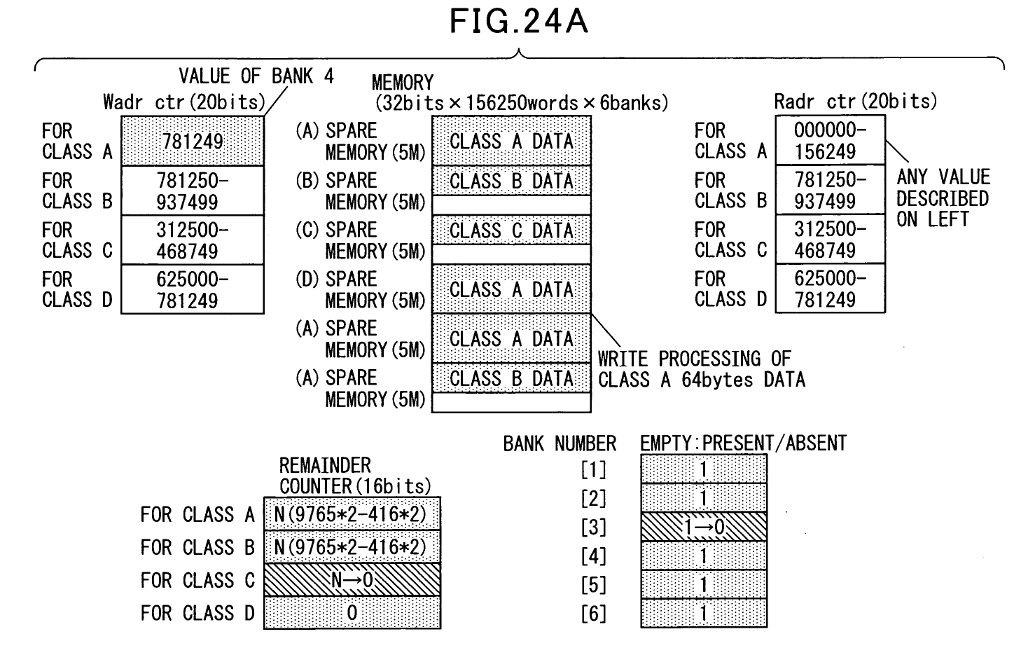

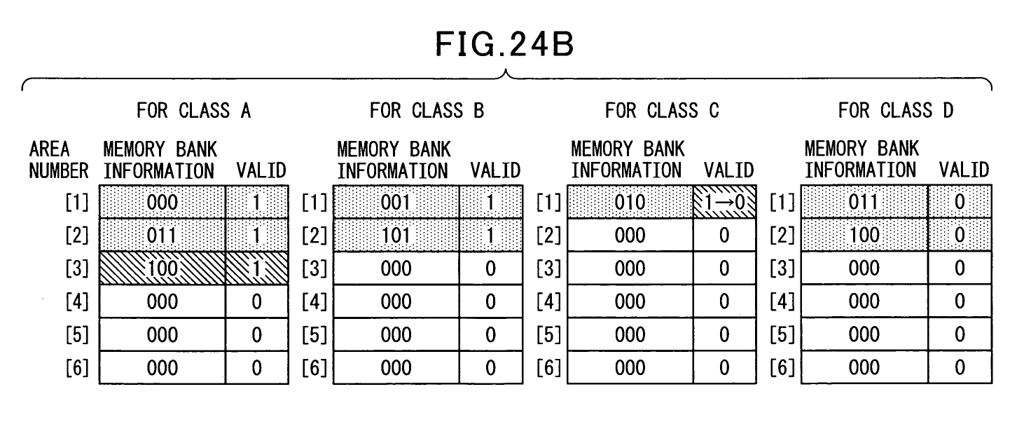

FIGS. 24A and 24B show an operation for further receiving data of the class A and clearing the memory bank information of the class C having a lower degree of priority than the received data and having the lowest degree of priority among the information stored in the memory. When a frame is received when the memory empty space management bit is “1” for all of the memory banks, the bank having the valid bit of memory bank information becoming “1” of the class of the lowest degree of priority among the classes of degrees of priority lower than that of the class of the received frame is detected, and the valid bit thereof is cleared to “0”.

In this example of operation, the valid bit of the class C is cleared to “0”. The memory bank information is “010” indicating the memory bank #3, therefore the value of the memory bank #3 in the memory management bits is cleared to “0”. Further, the remainder counter of the class C is made 0.

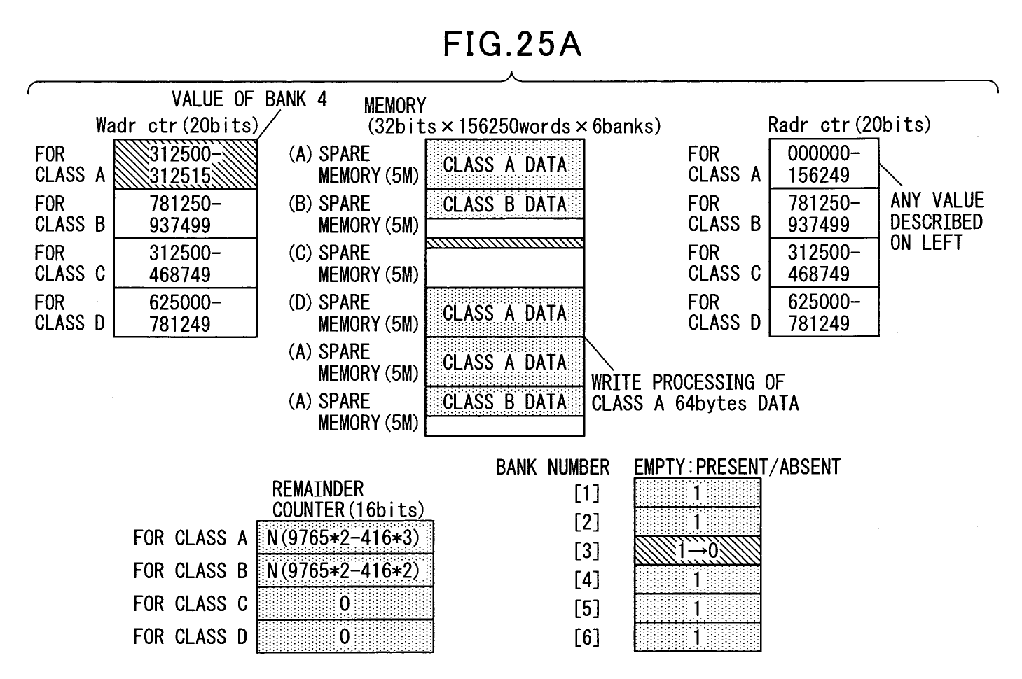

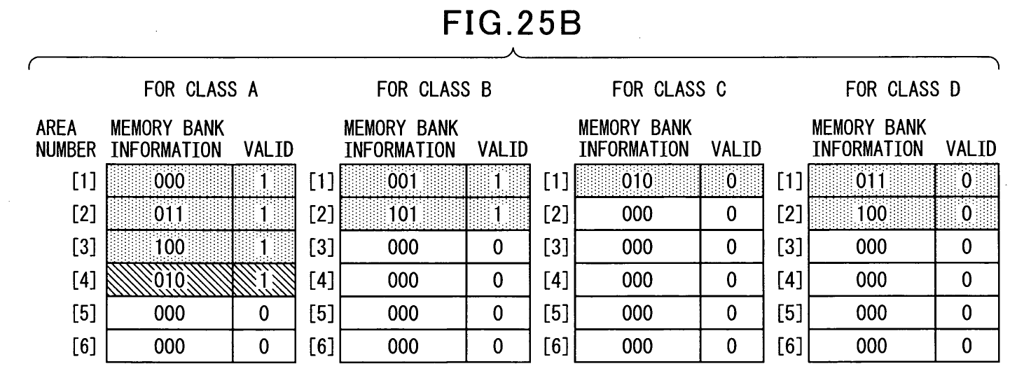

FIGS. 25A and 25B show an example of the operation for receiving 64 bytes of data of the class A and writing the same into the memory bank #3. The write address controller (Wadr_ctr) of the class A counts up the address of the memory bank #3 from the header address 312500 to 312515. “010” indicating the memory bank #3 is set in the fourth area of the memory bank information of the class A, and the valid bit thereof is set at “1”. Further, the bit of the memory bank #3 in the memory empty space management bits is set at “1”. In this way, it becomes possible to store data of a high degree of priority with a higher priority in an area even in a state where the data of a low priority is stored in the memory.

Next, embodiments modifying the basic configuration of the present invention mentioned above will be explained. A first modification is an example of configuration setting a memory area guaranteeing the lowest limit of area for each class and a memory area of the maximum limit able to be used. The memory area of the lowest limit and the memory area of the maximum limit can be freely set for all classes, but in this example of configuration, only the classes C and D are overwritten in the memory and discarded. The classes A and B are not overwritten once they are written into the memory.

Classes A and B of high degrees of priority are always written into the memory even when there is no empty space in the memory by being written over data with low priority, but an upper limit is previously set for the memory area usable when there is no empty space in the memory. A memory area is guaranteed up to the above upper limit as the maximum limit of usable memory area when there is no empty space in the memory. For classes C and D, the previously determined lowest limit memory area is guaranteed, but the use of an area usable more than that becomes possible within the range of the empty area only in a case where there is an empty space in the memory. By setting this, the high priority class can be prevented from monopolistically eating up the memory area.

As an example of setting the lowest limit of usable memory, each class can use a memory amount of 4 Mbits as the lowest limit. Due to this, all classes are guaranteed the use of the lowest limit of memory without being influenced by other high priority classes. Further, as an example of setting the maximum limit of usable memory, the high degree of priority can always use up to 10M of the memory.

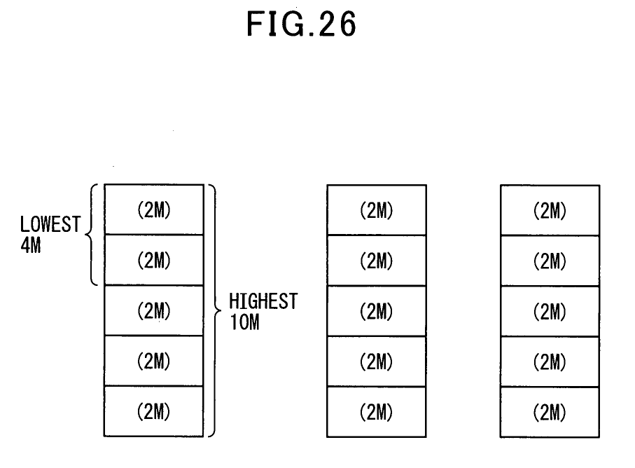

In a second example of configuration explained below, 15 memory banks each having a capacity of 2 Mbits are used as shown in FIG. 26, so the memory capacity becomes 30 Mbits in total. Each class can use at least two memory banks, and the high degree of priority can use five memory banks as the maximum limit. Further, in order to simplify the explanation in this example of configuration, it is assumed that data of fixed length frames is handled, and 10 frames' worth of data is stored in each memory bank.

Accordingly, the following example of operation will be explained by assuming that each memory bank has 10 address spaces by simple address conversion of 1 frame, and the write address controller (Wadr_ctr) and the read address controller (Radr_ctr) count up one address worth of data at the time of writing and reading 1 frame.

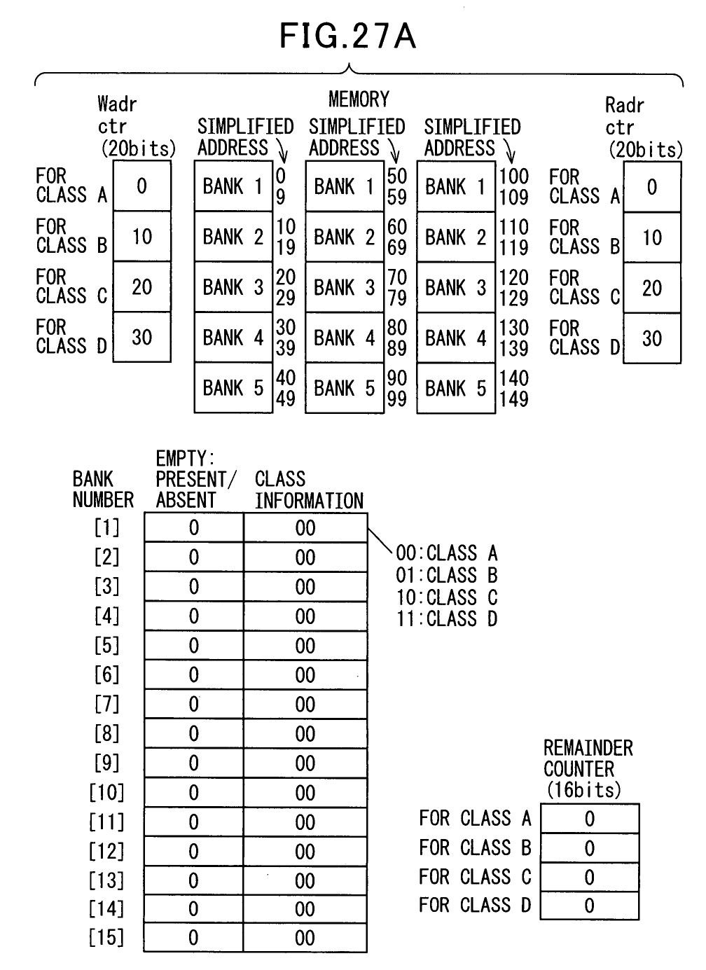

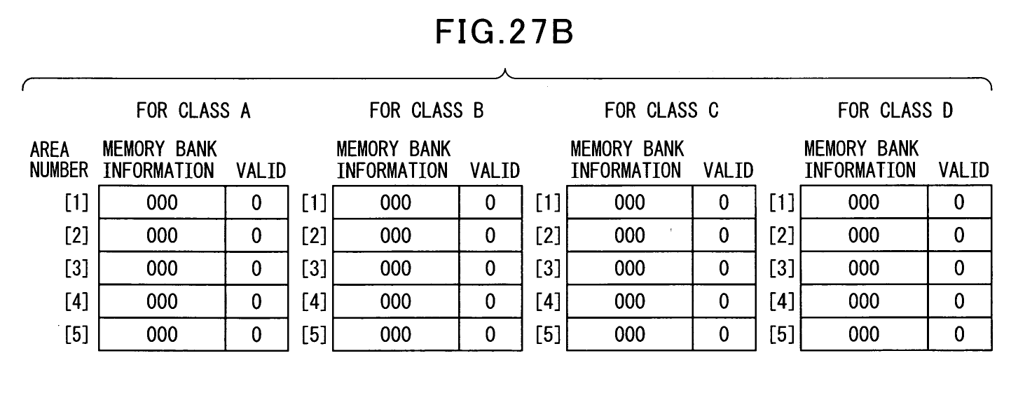

FIGS. 27A and 27B show the initial state in the above second example of configuration. Further, as shown in the figure, in the second example of configuration, a memory for holding class information indicating the classes in use (00: class A, 01: class B, 10: class C, 11: class D) together with the memory empty space management bit is provided for each memory bank. The rest of the configuration is the same as the above first example of configuration.

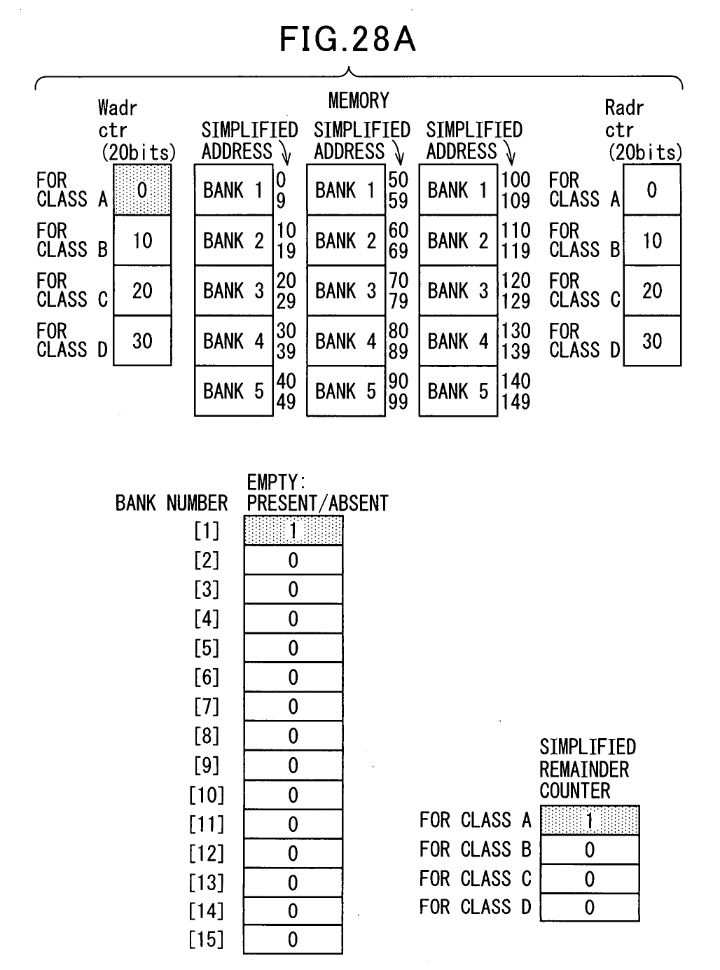

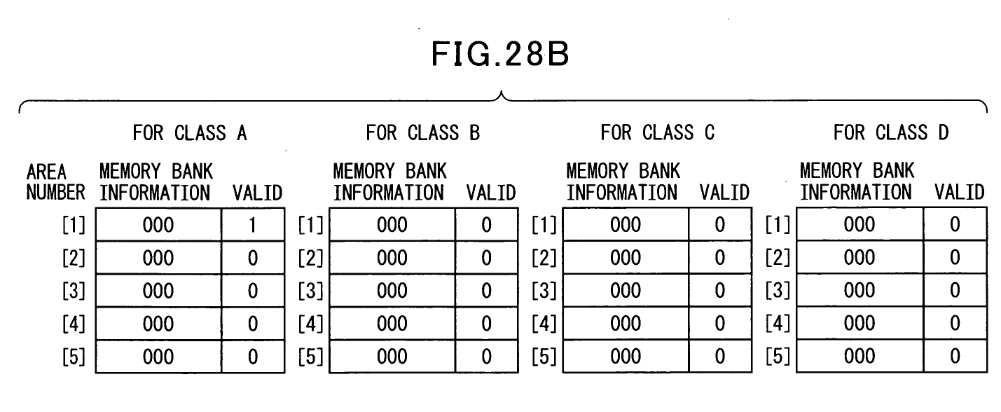

In FIGS. 28A and 28B, the data of the class A is received, the discrimination information “001” indicating the memory bank #1 is stored in the first area of the memory bank information of the class A, the valid bit thereof is set at 1, “1” is set in the memory bank #1 of the memory empty space management bits, and the simplified remainder counter is set at 1.

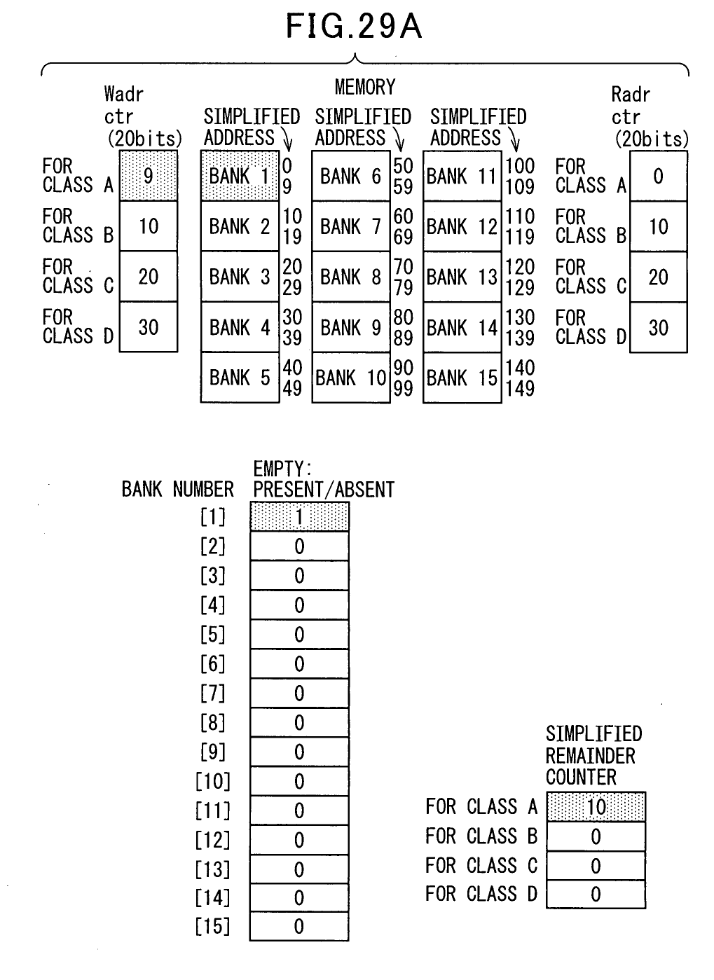

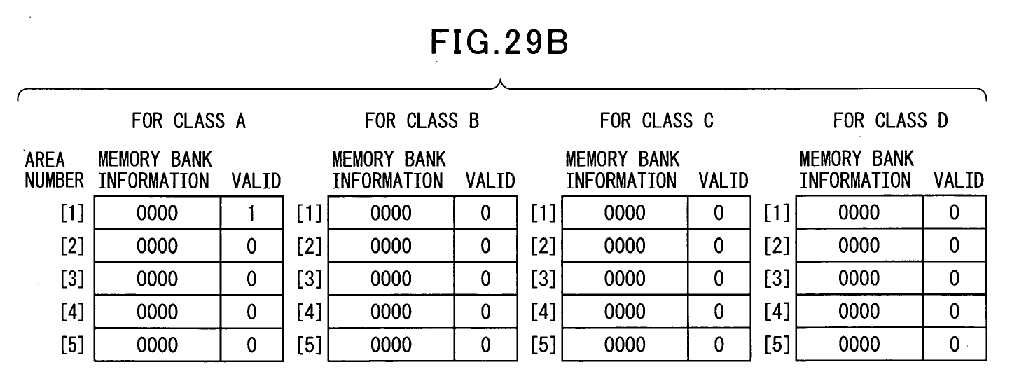

FIGS. 29A and 29B show a state where 10 frames of data of the class A are received, the data are stored in the memory bank #1, and the write address controller (Wadr_ctr) counts up to 9 in the simplified address conversion. In the following explanation, the processing for storing the received data in the memory assuming that the read control has stopped will be explained in detail.

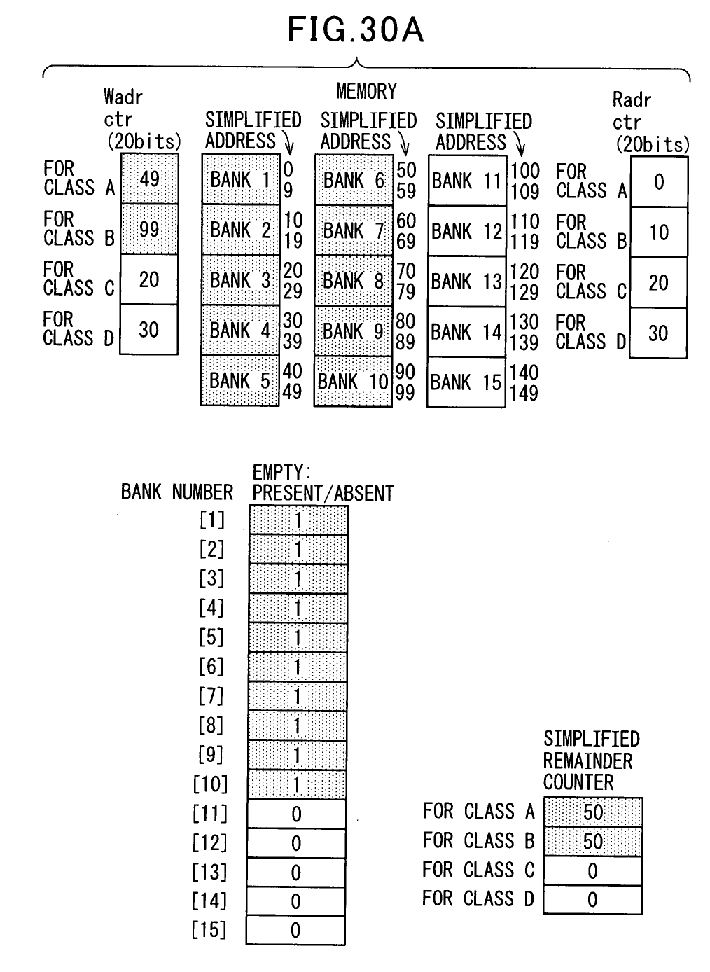

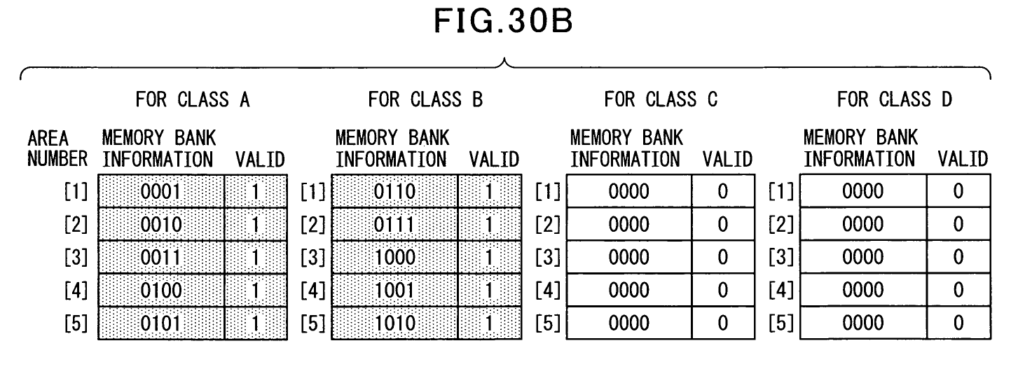

FIGS. 30A and 30B show a state where 50 frames of data of the class A are received, the data are stored in the memory banks #1 to #5, the write address controller (Wadr_ctr) counts up to 49 in the simplified address conversion, “0001” to “0101” indicating the discrimination information of the memory banks #1 to #5 are stored in the first to fifth areas of the memory bank information of the class A, the valid bits of these are set at 1, “1” is set for each of the memory banks #1 to #5 of the memory empty space management bits, and the simplified remainder counter for the class A is set at 50.

FIGS. 30A and 30B show a state where 50 frames of data of the class B are further received, the data are stored in the memory banks #6 to #10, the write address controller (Wadr_ctr) counts up from 50 to 99 in the simplified address conversion, “0110” to “1010” indicating the discrimination information of the memory banks #6 to #10 are stored in the first to fifth areas of the memory bank information of the class B, the valid bits of these are set at 1, “1” is set in each of memory banks #6 to #10 of the memory empty space management bits, and the simplified remainder counter for the class B is set at 50.

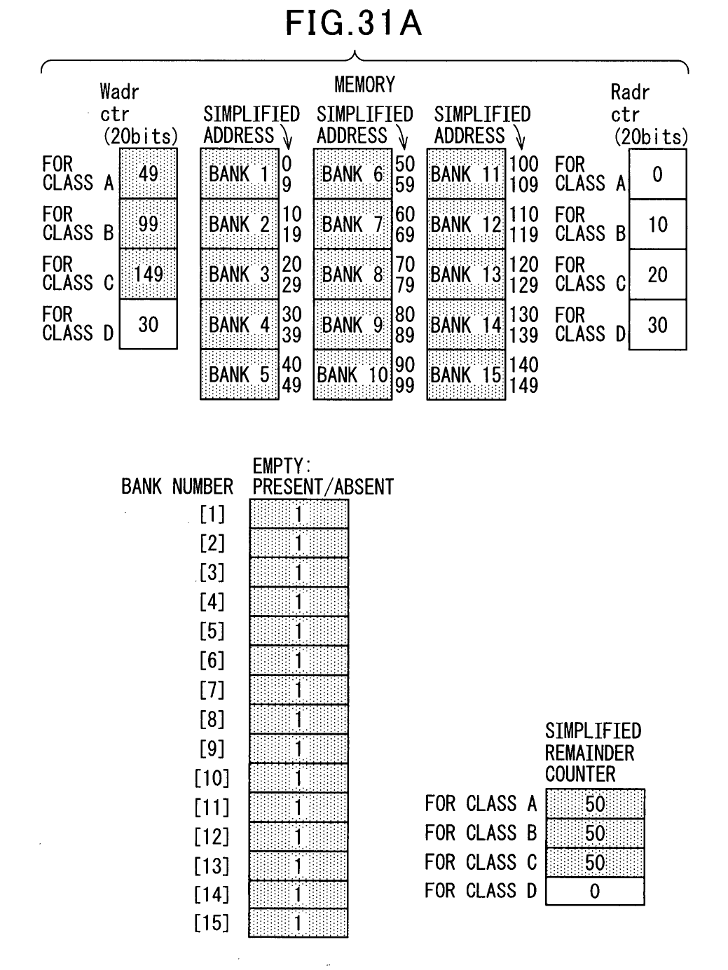

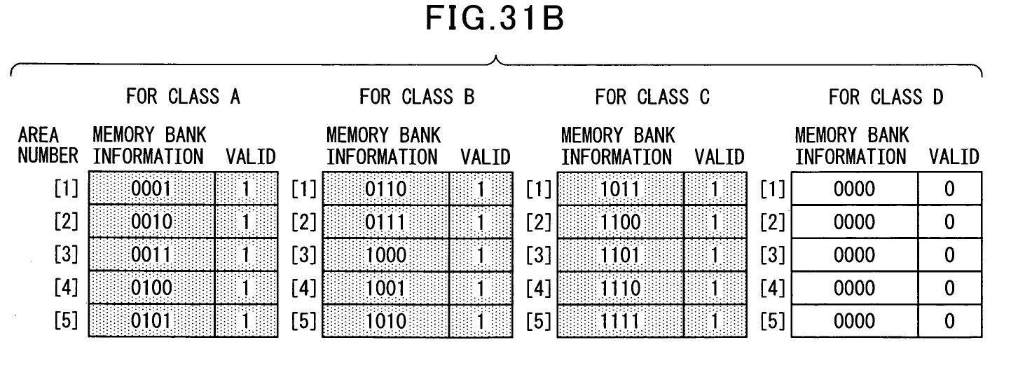

FIGS. 31A and 31B show a state where 50 frames of data of the class C are received after the state of FIGS. 30A and 30B, the data are stored in the memory banks #11 to #15, the write address controller (Wadr_ctr) counts up from 100 to 149 in the simplified address conversion, “1011” to “1111” indicating the discrimination information of the memory banks #11 to #15 are stored in the first to fifth areas of the memory bank information of the class C, the valid bits of these are set at 1, “1” is set for each of the memory banks #11 to #15 of the memory empty space management bits, and the simplified remainder counter for the class C is set at 50.

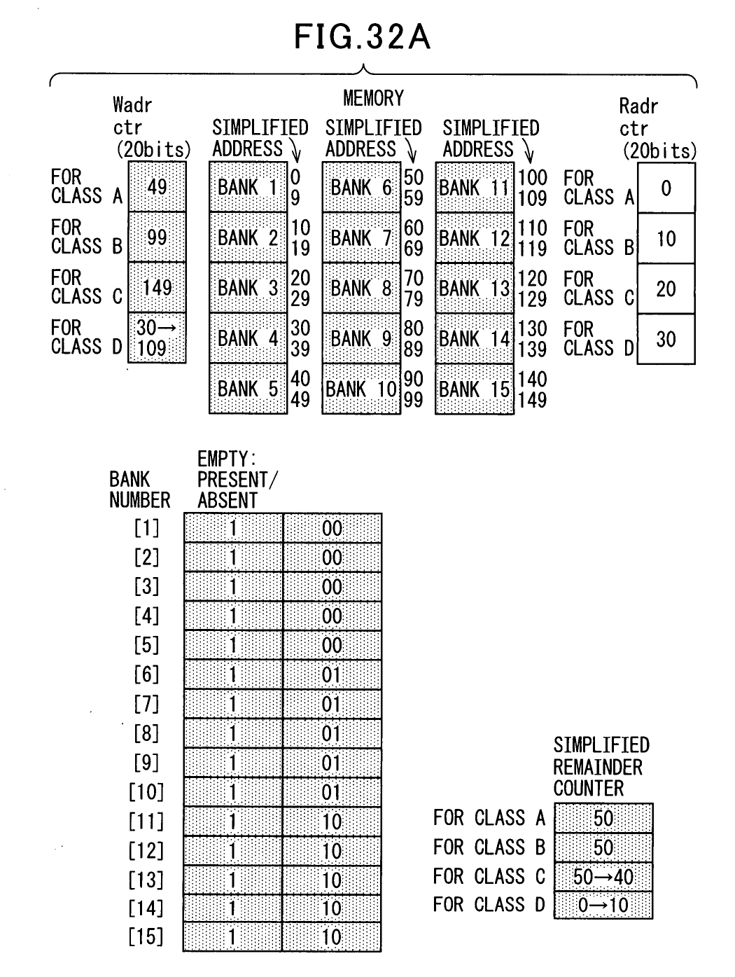

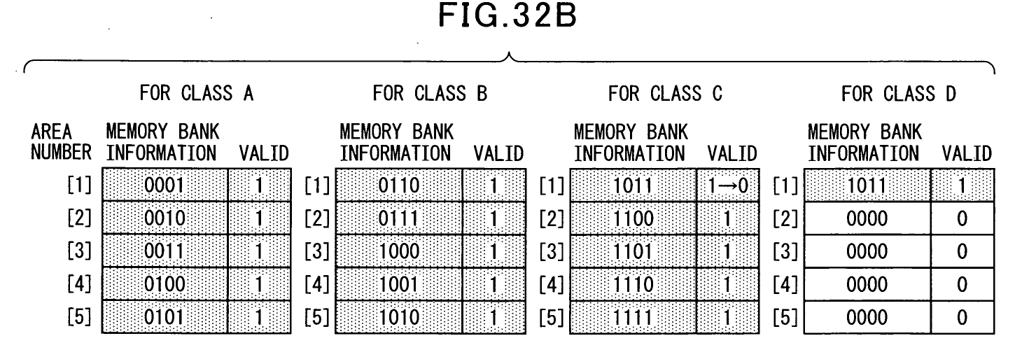

FIGS. 32A and 32B show a state where 10 frames' worth of data of the class D are received after the state of FIGS. 31A and 31B. At this time, since there is no empty memory bank for storing the data of the class D, the write controller discards the data of the memory bank #11 used by the class C of the lowest degree of priority among the classes of data being stored and dynamically assigns the memory bank #11 for storage of the data of the class D. This is for guaranteeing the lowest limit of memory area. Even when the assignment of the memory bank #11 is discarded from the class C, the lowest limit of memory area is still guaranteed for the class C.

From the above, the write address controller (Wadr_ctr) of the class D jumps from 30 in the initial setting to the header address 100 of the bank #11 and counts up to 109 therefrom. Then, it clears the valid bit of the memory bank #11 (discrimination information “11011”) of the first area of the memory bank information of the class C to “0”, sets “1011” indicating the memory bank #11 in the first area thereof as the memory bank information of the class D, and sets the valid bit thereof at “1”. Further, the simplified remainder counter of the class C subtracts 10 frames from 50 to obtain 40 and sets it, while the simplified remainder counter of the class D adds 10 frames to 0 to obtain 10 and sets it.

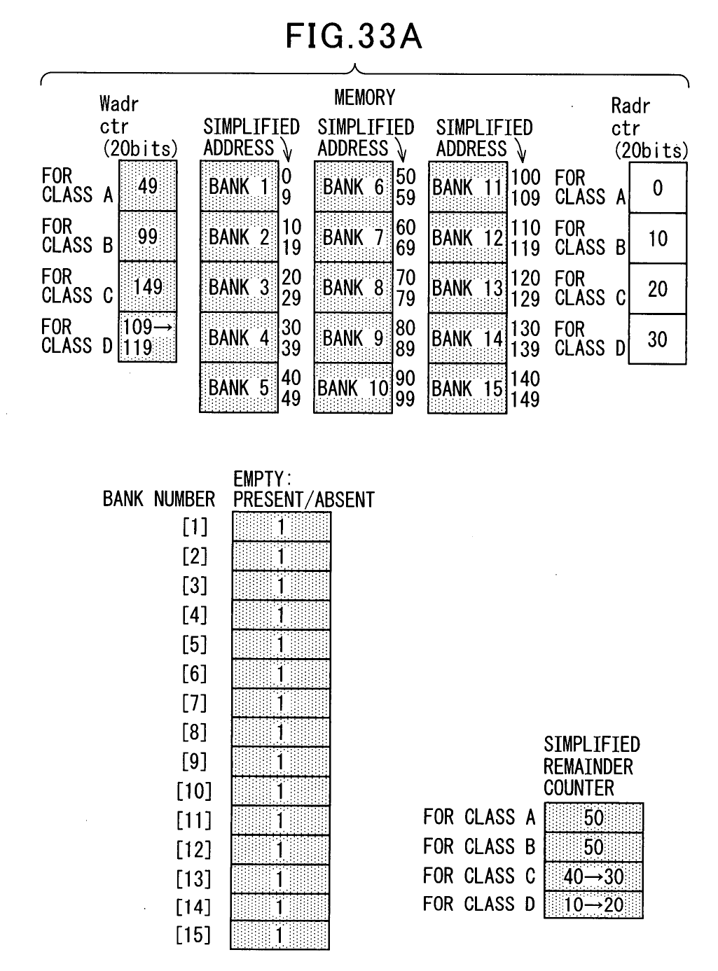

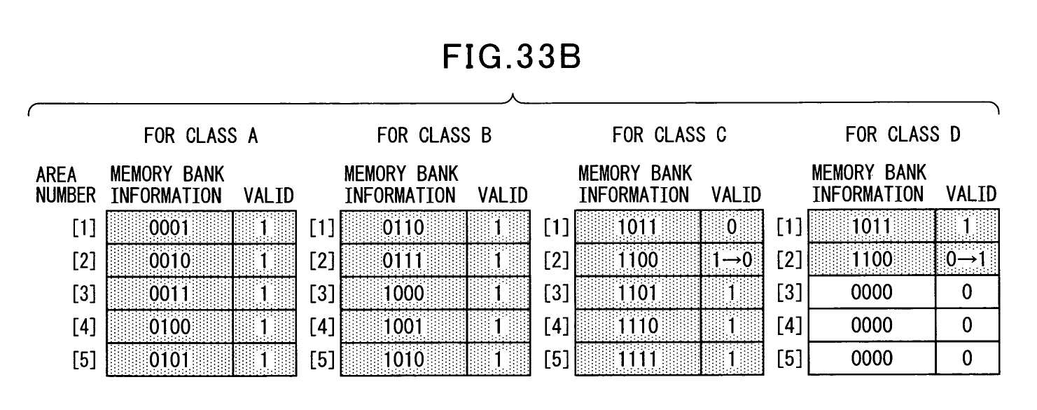

FIGS. 33A and 33B show a state when further receiving 10 frames' worth of data of the class D after the state of FIGS. 32A and 32B. In this case as well, in the same way as the example of operation of FIGS. 32A and 32B, since there is no empty memory bank for storing the data of the class D, the write controller discards the data of the memory bank #12 used by the class C of the lowest degree of priority among the classes for which data is being stored and dynamically assigns the memory bank #12 to the storage of the data of the class D.

For this reason, the write address controller (Wadr_ctr) of the class D moves to the header address 110 of the bank #12 and counts up to 119 therefrom. Then, it clears the valid bit of the memory bank #12 (discrimination information “1100”) of the second area of the memory bank information of the class C to “0”, sets “1100” indicating the memory bank #12 in that second area, and sets the valid bit thereof at “1”. Further, the simplified remainder counter of the class C subtracts 10 frames from 40 to obtain 30 and sets it, while the simplified remainder counter of the class D adds 10 frames' worth to 10 to obtain 20 and sets it.

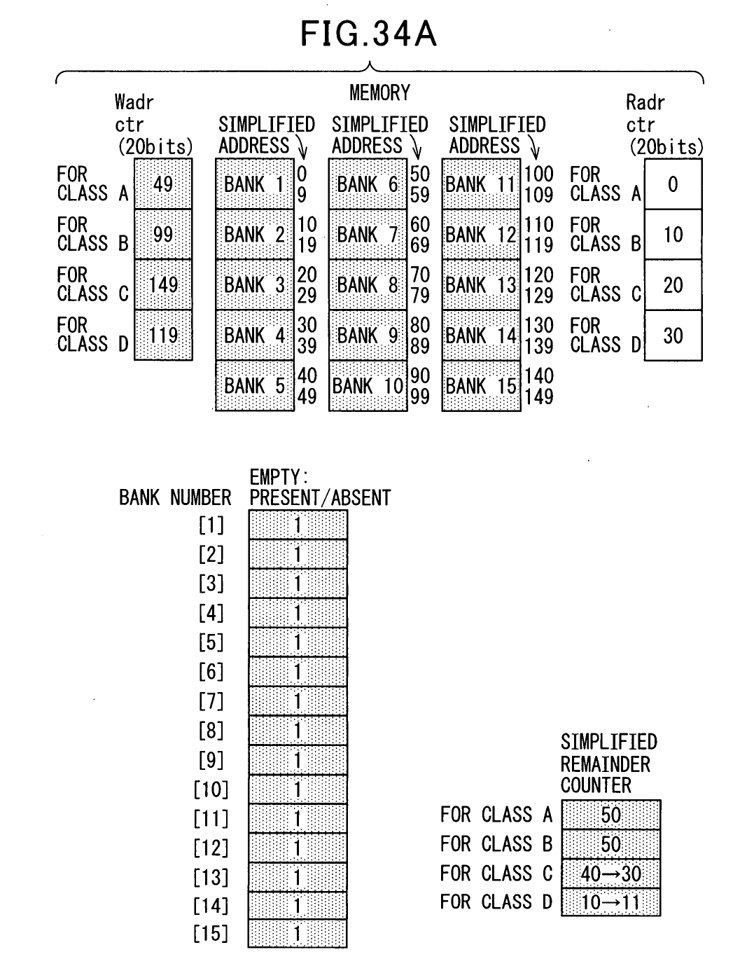

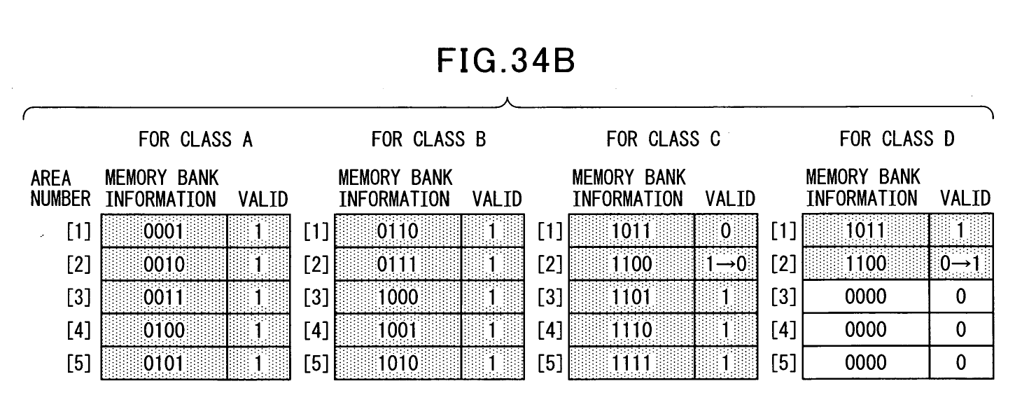

FIGS. 34A and 34B show a state of securing up to the maximum limit area of 10 Mbits for each of the data of the class A and the class B and a state of securing the lowest limit area of 4 Mbits or more for the class C and the class D and further an area of 6 Mbits in total is used by the class C. In this state, all of the Mbits of memory are used, so there is no empty area, therefore overflow occurs when data of any of the classes A, B, C, and D is received, and the received data is discarded.

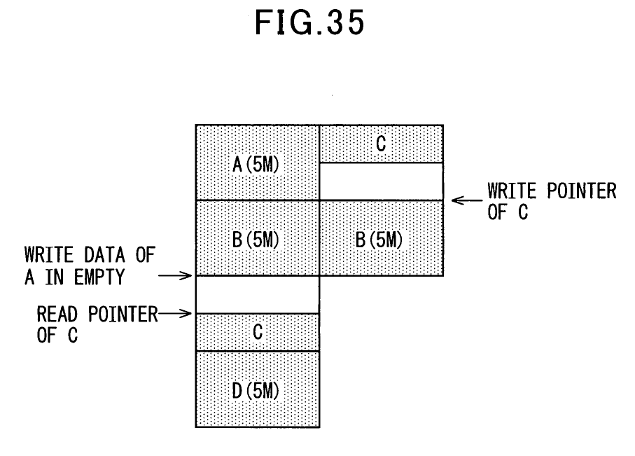

FIG. 35 shows an example of the operation when writing data of a high priority class into a memory bank where the data of a low priority class is already stored and when the data of the low priority class is not immediately discarded, but first data starts to be written from the area for which readout has finished and then, when the write pointer of the data of the high priority class catches up with the read pointer of the data of the low priority class, the data of the low priority class is discarded.

Namely, the data of the class A is written into an empty area of the memory bank in which the data of the class C is stored. The data of the class C is held as is until the position of the write pointer comes to the position of the read pointer of C. When it comes to the position of the read pointer of the data of the class C, priority is given to the data of the class A and all of the data of the class C are discarded, but the data of the class A and the class C use the same memory bank until the pointers are superimposed.

If the data of the class C finished being read before the write pointer of the data of the class A catches up with the read pointer of the data of the class C, the data of the class C is not discarded. The memory is shared in the same memory bank, so and the memory can be effectively utilized.

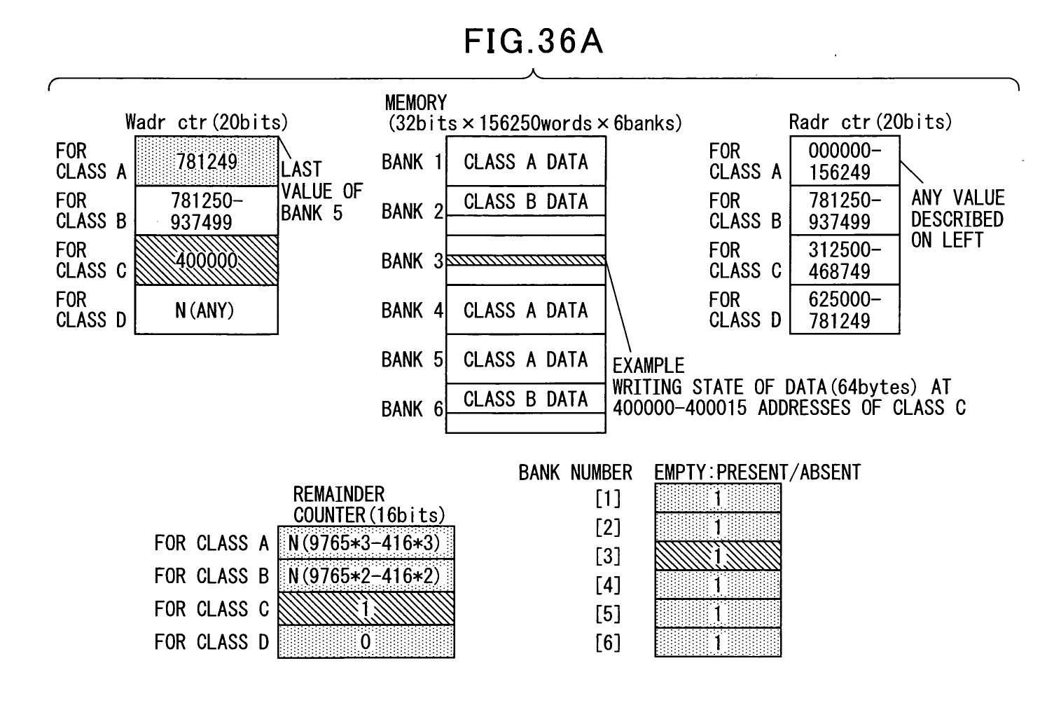

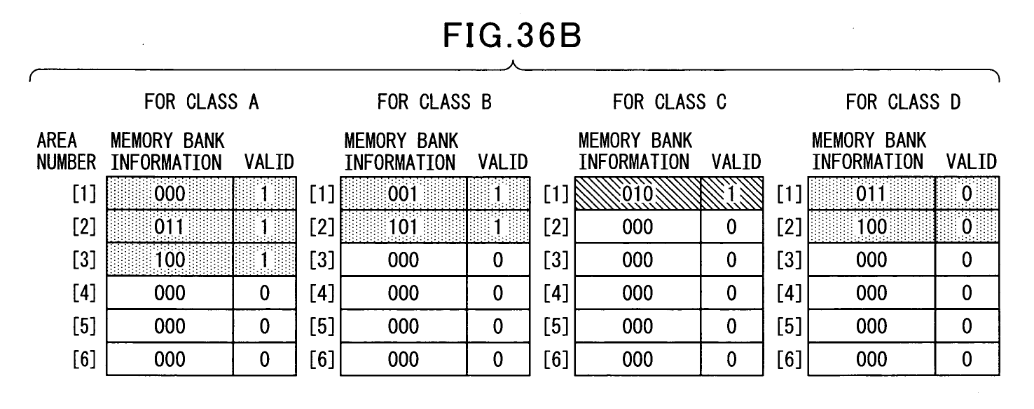

FIGS. 36A and 36B to FIGS. 38A and 38B show specific examples of the operation explained in FIG. 35. FIGS. 36A and 36B show a state of operation where the data are stored in all memory banks in the first example of configuration mentioned before, the data of the class A is stored in the memory banks #1, #4, and #5, the data of the class C is stored in the memory bank #3, the write address controller (Wadr_ctr) of the class C counts up the address of the memory bank #3 from 400000 to 400015, and the received 64 bytes of data of the class C is written. The memory bank information of each class, the remainder counter, and the memory empty space management bit of each memory bank are set as shown in the same figure.

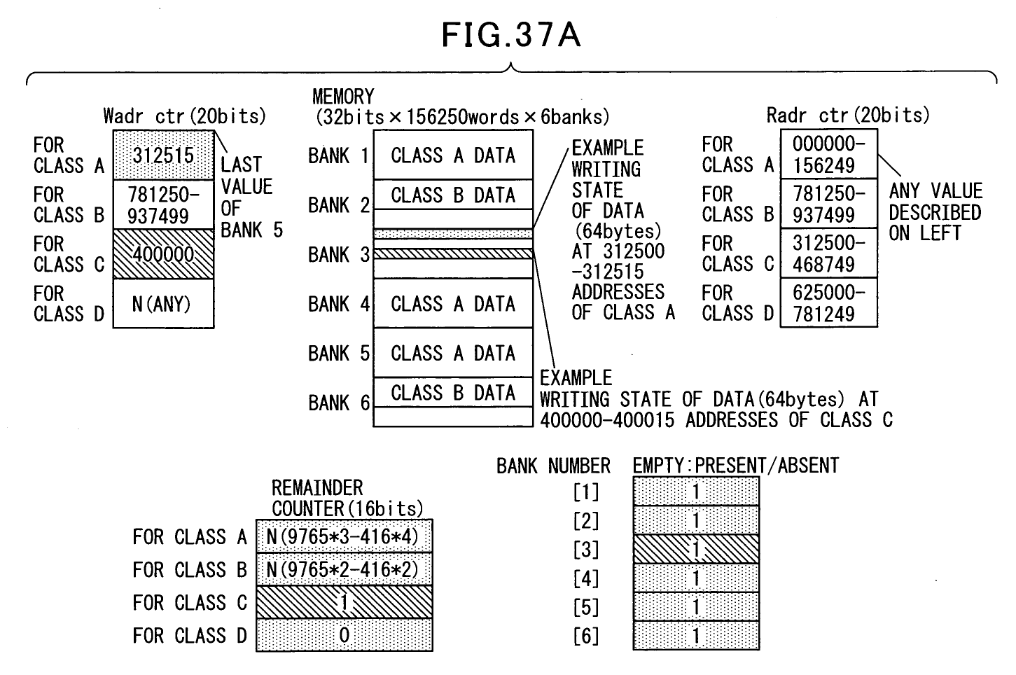

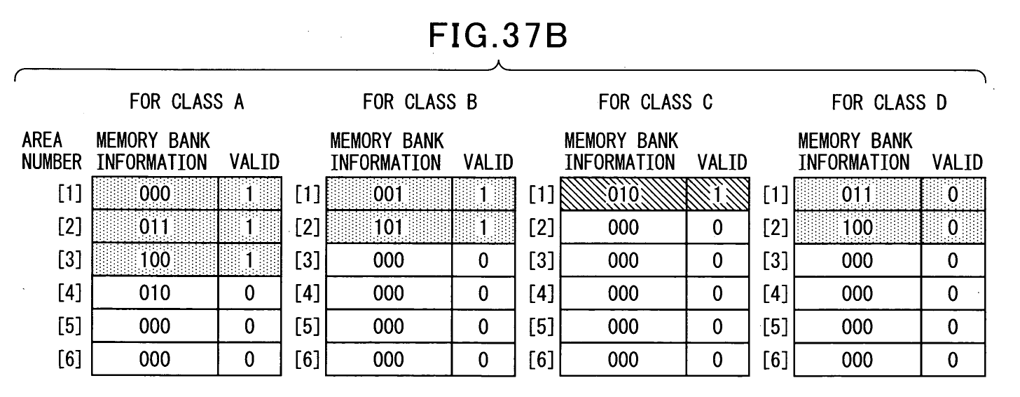

FIGS. 37A and 37B show a state of operation when the 64 bytes of data of the class A are received after the state of FIGS. 36A and 36B, that is, shows an example of operation where the data of the class A (64 bytes) is written at addresses 312500 to 312515 in the memory bank #3 as shown in the same figure and the data of the class C (64 bytes) is written at addresses 400000 to 400015.

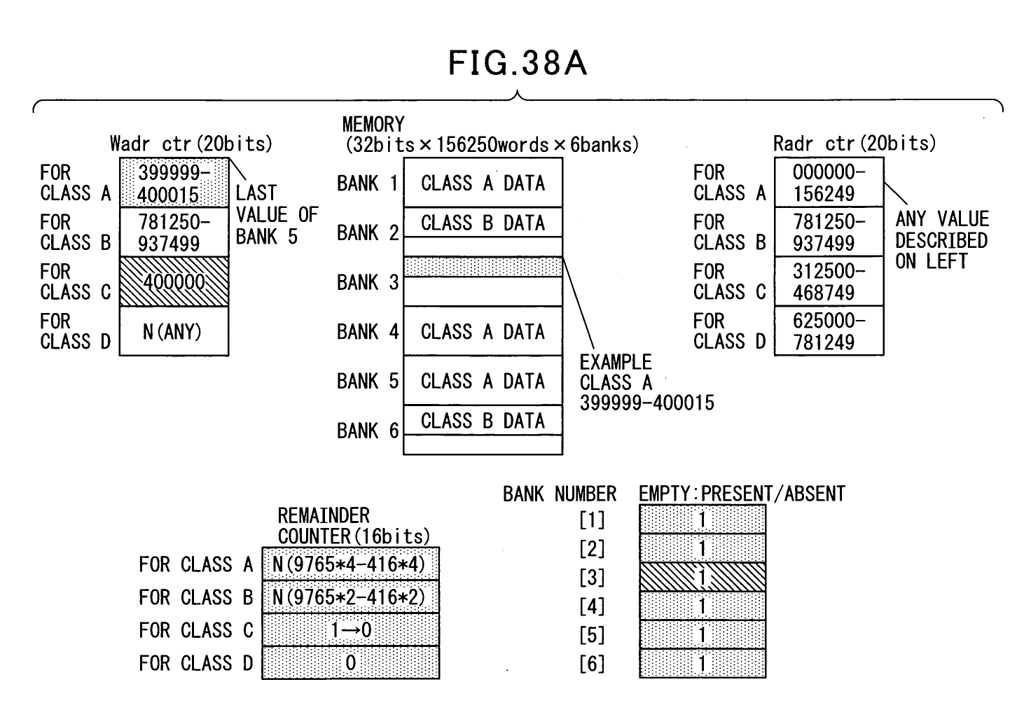

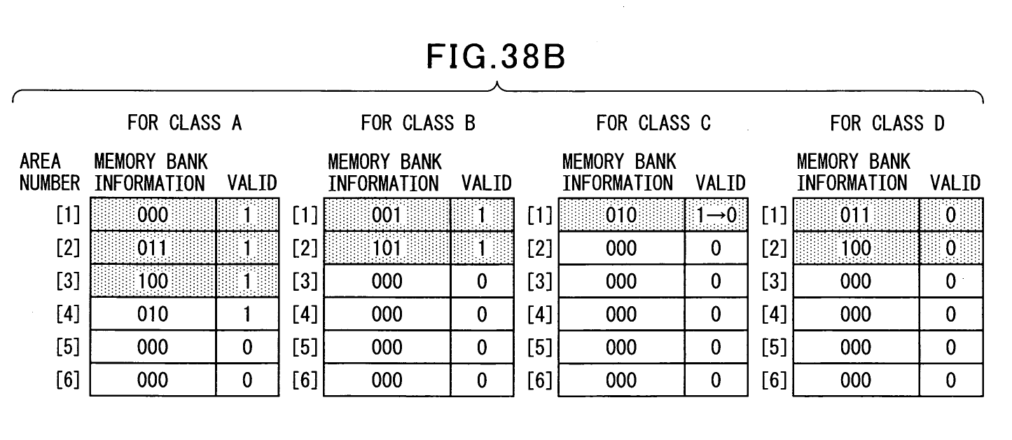

In FIGS. 38A and 38B, after the state of FIGS. 37A and 37B, the data of the class A is further received, the data are stored up to the address 399999, and, when writing the data at the address 400000 at which the data of the class C is already stored, the data of the class C is discarded, and the data of the class A is written over it. Then, the memory bank information of the class C is cleared from “1” to “0”, and the remainder counter of the class C is cleared to 0.

In this way, it is possible to write data of classes of different degrees of priority into the same memory bank. In the previously explained embodiments, the data of classes of different degrees of priority could not be stored in the same memory bank, but by referring to the pointer for each class as described above, the data of different classes can be stored up to just before the superimposition of pointers on each other in the same memory bank, so the effective usage of the memory becomes possible.

This is because, by comparing the address of the write address controller (Wadr_ctr) of the class A and the address of the read address controller (Radr_ctr) of the class C, when the address of the write address controller (Wadr_ctr) of the class A is less than the address of the read address controller (Radr_ctr) of the class C, data of different classes can be made to co-exist in the same memory bank.

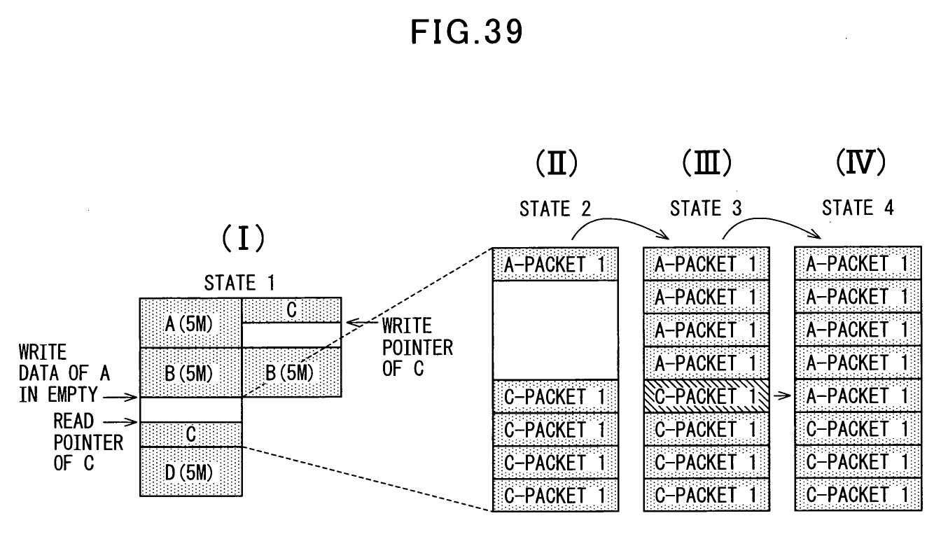

FIGS. 39A and 39B are diagrams showing a method of performing the operation explained in FIG. 35 etc. mentioned before in units of packets. As in the first state shown in (i) of FIG. 39, when 1 packet of the class A is written into the empty area from the first state where the write pointer of the class A is set at an empty area of the memory bank in which the data of the class C is already stored, the second state shown in (ii) of the same figure is exhibited.

When writing 4 packets of the class A in total from the above second state, a third state shown in (iii) of the same figure is exhibited, and a state where the write pointer of the class A catches up with the read pointer of the class C is exhibited. A configuration is formed wherein, when writing 1 packet of the class A from this third state, all of the packets of the class C are not discarded, but packets are discarded in units of 1 packet, although packets of the class A are written into the memory with a high priority, also packets of the class C are kept alive as much as possible.

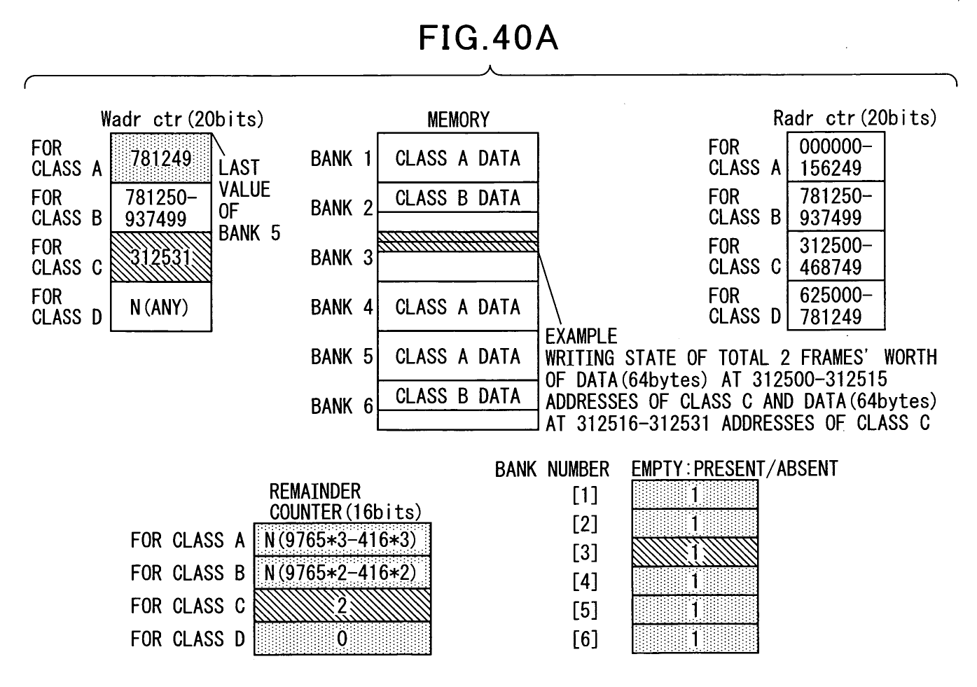

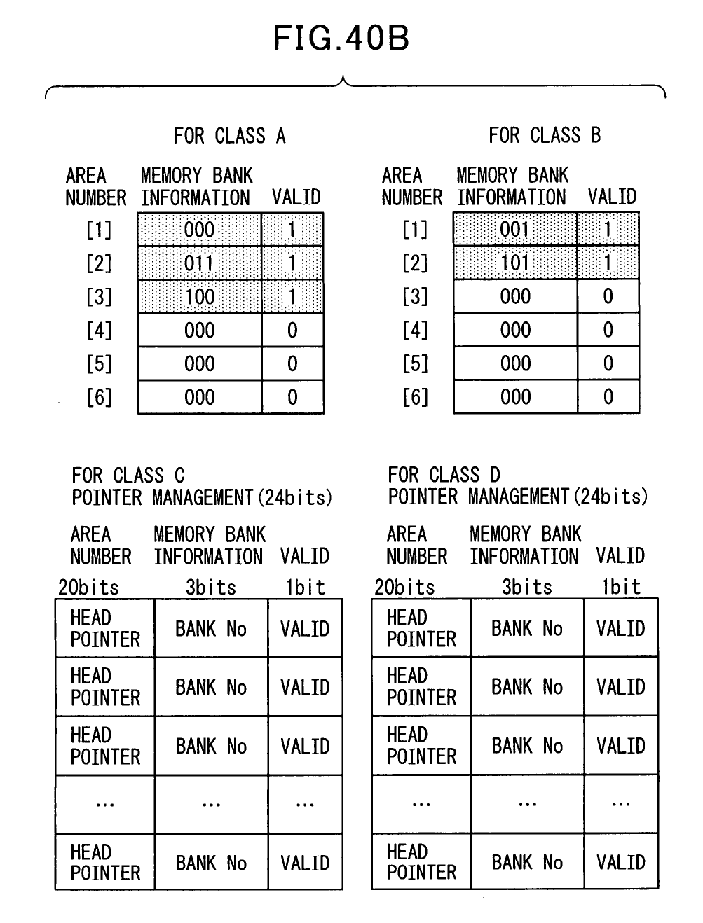

FIGS. 40A and 40B explain the above configuration of discarding data in units of packets in detail. Note that, in order to simplify the explanation, it is assumed that frames having a fixed length are being processed. Further, as the prerequisite condition of configuration, the data of low priority of the class C and the class D are overwritten by the data of the class A and the class B of high degree of priority, but the data of the class A and the class B are not overwritten. For this purpose, the pointer management of the class C and the class D having a possibility of overwriting is carried out.

A memory for storing the information for this pointer management becomes necessary. The capacity of the memory becomes as follows. As a memory replacing the memory bank information used for each class mentioned before, for the class C and the class D, a memory having for example 20 storage areas of the point management information having a bit width of 24 bits is prepared. Here, the bit width 24 bits is a sum of the 20 bits' worth of the header point, 3 bits' worth of the discrimination information of the memory bank, and 1 bit's worth of the valid bit.

Assuming that six memory banks each having a capacity of 5 Mbits are used for 20 bits of the header pointer, and the data of 32 bits (=1 word) is stored pe address, there are 156250 addresses per memory bank, the whole six memory banks have an address space of 937500 (=156250×6) (dec)=E4E1C (hex), and 20 bits become necessary for representing this.

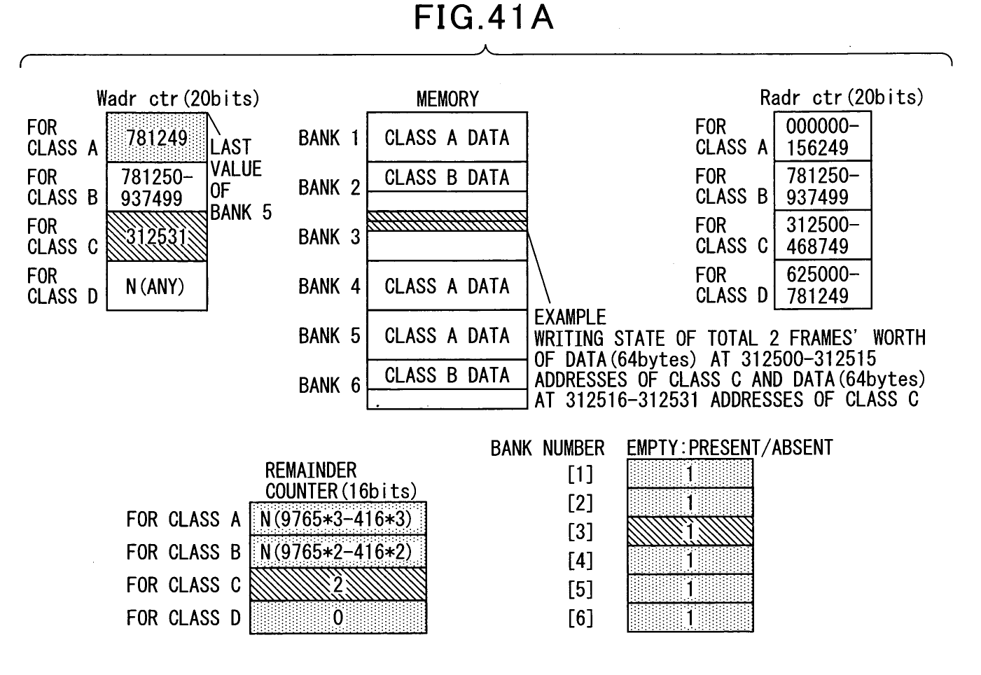

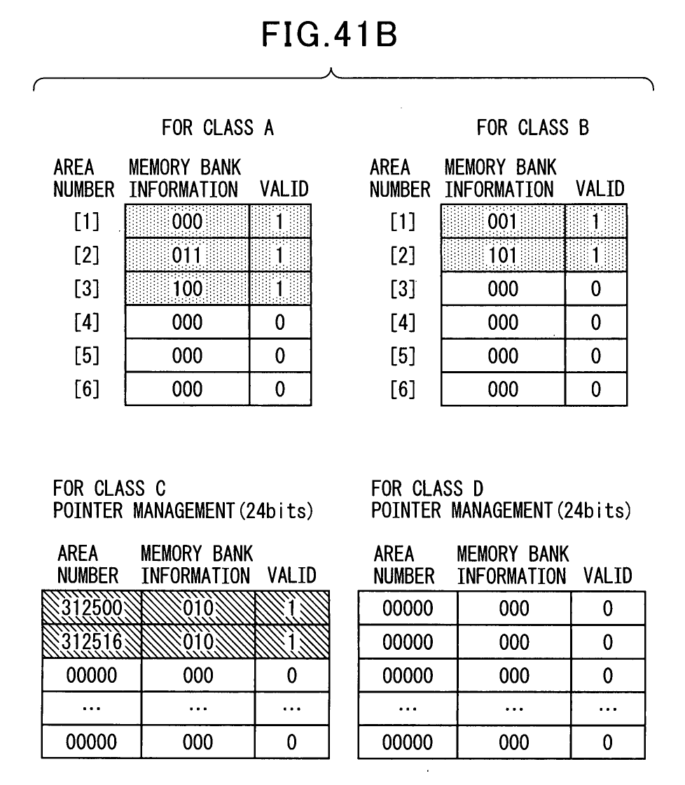

FIGS. 41A and 41B show a state where data are stored in all of the six memory banks, and 2 frames' worth of the data of the class C are stored in the memory bank #3 at addresses 312500 to 312515 and 312516 to 312531. In the pointer management information of the class C, for the first frame, 312500 indicating the header pointer, “010” indicating the memory bank #3, and the valid bit “1” are set, and for the second frame, 312516 indicating the header pointer, “010” indicating the memory bank #3, and the valid bit “1” are set. The other information are the same as those in the examples of operation shown in the explanation hitherto, so the explanation will be omitted.

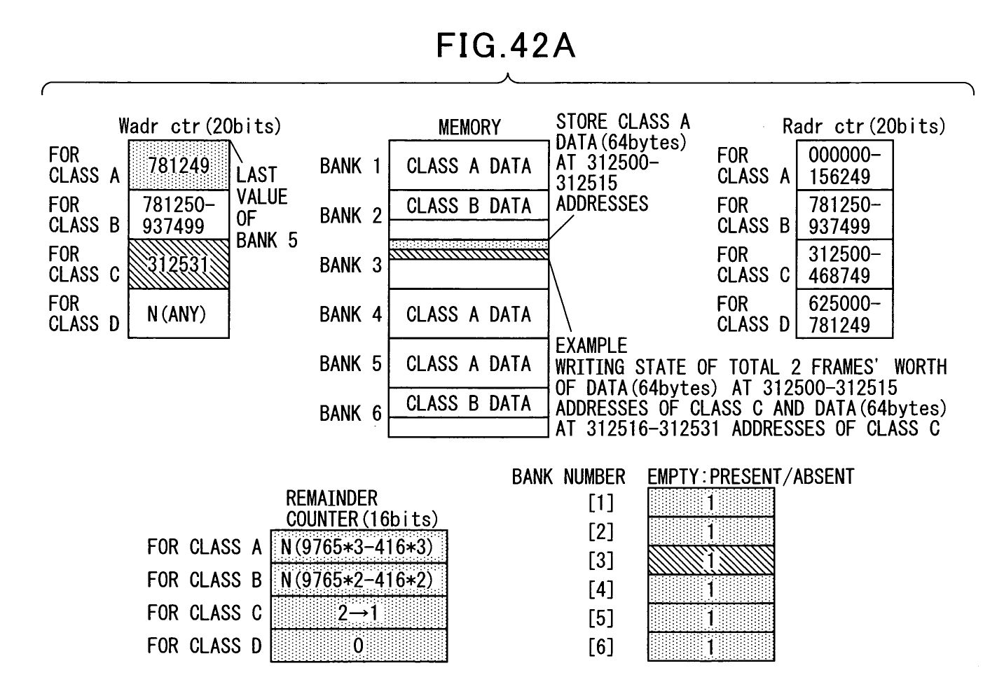

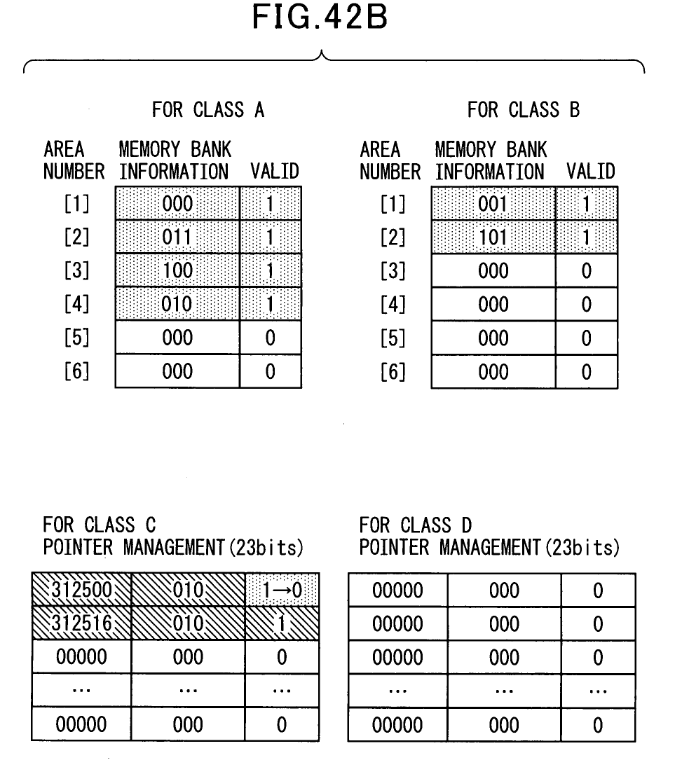

FIGS. 42A and 42B show a state of operation when receiving data of the class A after the state of FIGS. 41A and 41B. This data is written over the data of the class C. When receiving 64 bytes of data of the class A, as mentioned above, the data at the addresses 312500 to 312515 where the first frame of the class C of the low priority class is discarded, the data of the class A is stored there, and the valid bit of the first frame of the pointer management information of the class C is cleared to “0”.

However, the data at the addresses 312516 to 312531 at which the second frame of the class C are stored are not discarded, but the valid bit of the second frame of the pointer management information is held at “1” as it is, and the remainder counter of the class C is counted down from 2 to 1.

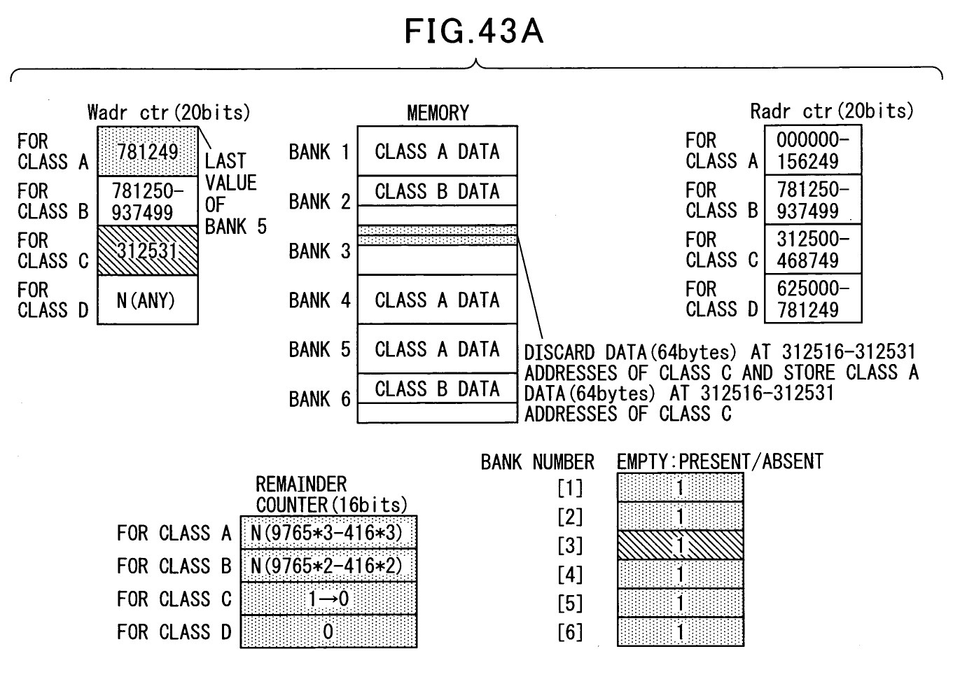

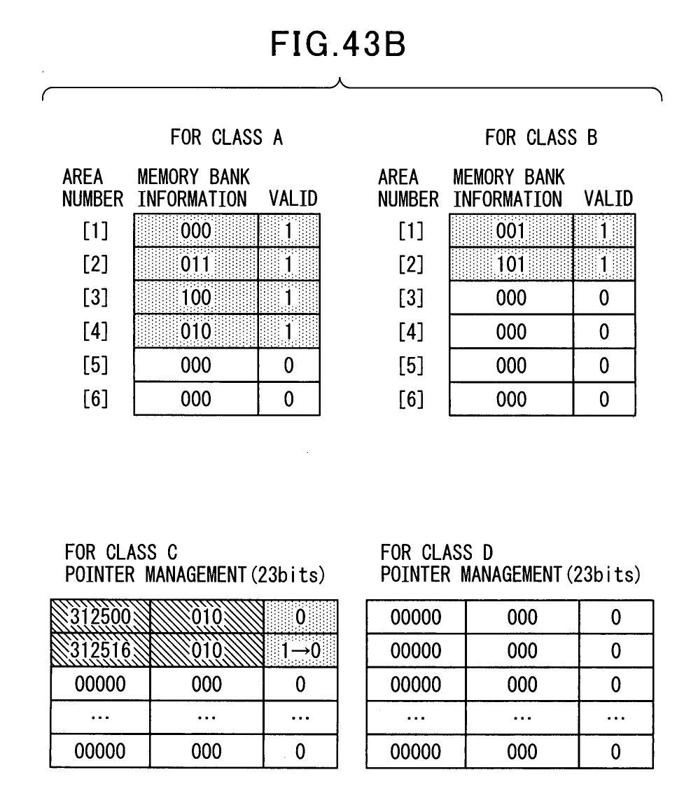

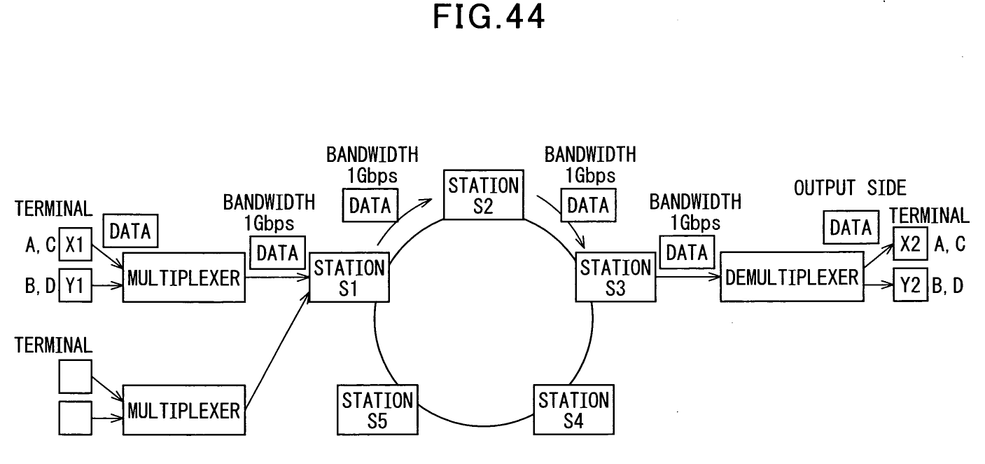

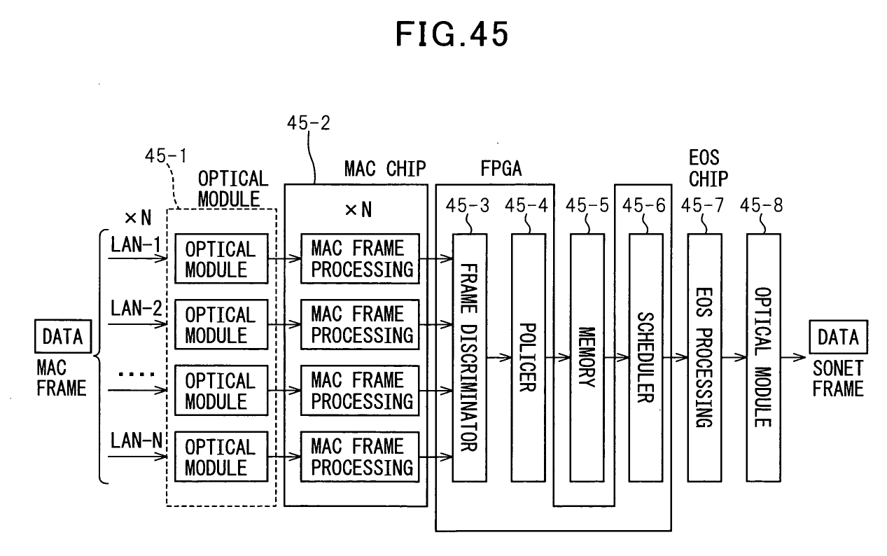

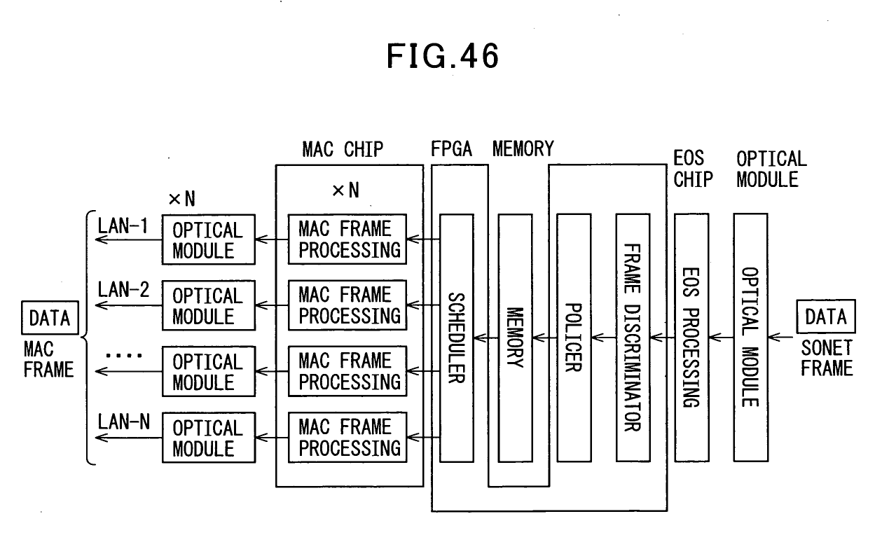

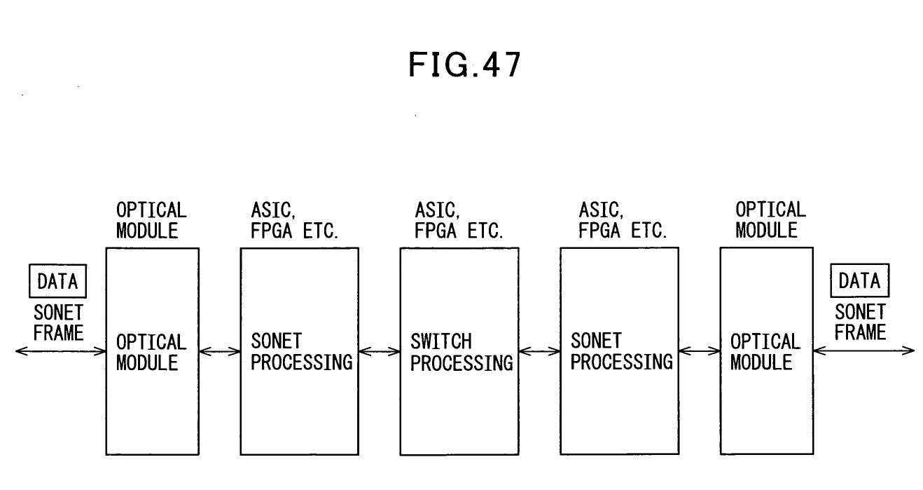

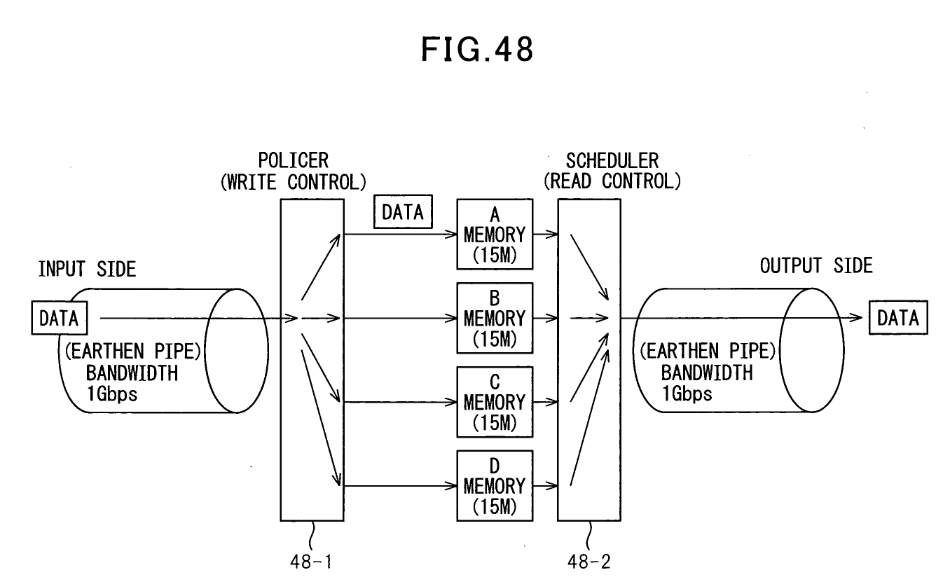

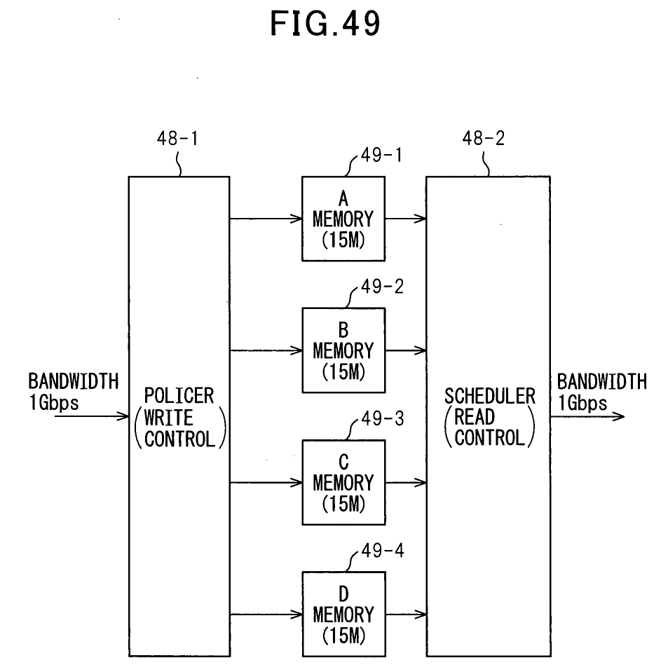

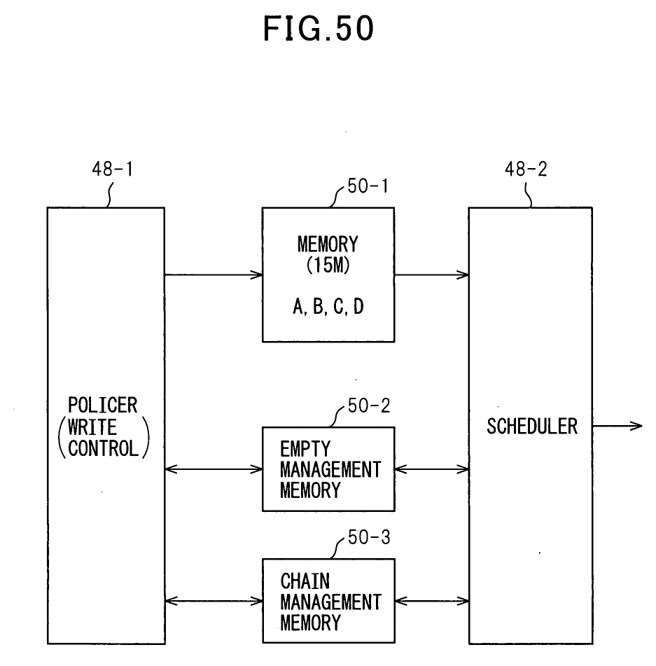

FIGS. 43A and 43B show a state of operation where the data of the class A is further received after the state of FIGS. 42A and 42B.

When further receiving 64 bytes of data of the class A, the data at the addresses 312516 to 312531 at which the above second frame of the class C had been stored are discarded, and the data (64 bytes) of the class A are stored at those addresses 312516 to 312531. Then, the remainder counter of the class C is counted down from 1 to 0, and the valid bit of the second frame of the pointer management information of the class C is cleared to “0”.

By managing the write pointer and the read pointer in units of frames (packets) in this way, it becomes possible to refer to the header address of the frame written at any address of the memory bank, compare the pointer value thereof and the write address of a newly received frame, carrying out the priority processing frame by frame, and thus realize effective utilization of the memory.

While the invention has been described with reference to specific embodiments chosen for purpose of illustration, it should be apparent that numerous modifications could be made thereto by those techniques in the art without departing from the basic concept and scope of the invention.

What is claimed is:

1. A method of dynamic management of memory in accordance with a priority class receiving as input frame data of a plurality of classes of different degrees of priority and storing or discarding the frame data in/from a memory of the frame data in accordance with the priority class of the frame data,
said method of dynamic management of memory comprising
partitioning an area of said memory into a plurality of areas to form memory banks and
having the different priority classes share said memory banks, dynamically assigning empty memory banks to the storage of frame data of the different priority classes, and controlling the writing, reading, and discarding of the frame data with respect to each memory bank assigned for each priority class.

2. A method of dynamic management of memory in accordance with a priority class as set forth in claim 1, further comprising:
defining a capacity smaller than a largest capacity among memory capacities for the priority classes required for storage of frame data for each of said priority classes input in a burst within a predetermined time as the capacity of said memory banks, and
storing a plurality of frame data for each priority class input in a burst by assigning said plurality of memory banks.

3. A method of dynamic management of memory in accordance with a priority class as set forth in claim 1, further comprising:
setting a lowest limit of usable memory and a maximum limit of usable memory for each of said priority classes and, when assigning said memory banks to the storage of the frame data of the different priority classes, assigning at least a memory bank having the lowest limit of usable memory for a priority class for which said lowest limit of usable memory is set and assigning memory banks up to the maximum limit of usable memory for a priority class in which said maximum limit of usable memory is set.

4. A method of dynamic management of memory in accordance with a priority class as set forth in claim 1, further comprising:
when storing frame data of a higher priority class in a memory bank which has been already assigned to the storage of frame data of a low priority class, sequentially writing frame data of the higher priority class from the area where the frame data of the low priority class has been already read out from the memory bank and
continuing to read out frame data of the low priority class without discarding the frame data of said low priority class until a write pointer indicating the address for writing the frame data of the higher priority class catches up with a read pointer indicating the address for reading the frame data of the low priority class from the memory bank.

5. An apparatus for dynamic management of memory in accordance with a priority class receiving as input frame data of a plurality of classes of different degrees of priority and storing or discarding the frame data in or from the memory in accordance with the priority class of the frame data,
said apparatus for dynamic management of memory in accordance with a priority class comprising:
memory banks configured by partitioning the area of said memory into a plurality of areas and
a write controller and a read controller for controlling the writing, reading, and discarding of said frame data in units of said memory banks and
having the different priority classes share said memory banks, dynamically assigning empty memory banks to the storage of frame data of the different priority classes, and controlling the writing, reading, and discarding of the frame data with respect to each memory bank assigned for each priority class.
